(19) United States
(12) Patent Application Publication
(10) Pub. No.: US 2016/0275627 A1
(43) Pub. Date: Sep. 22, 2016

(54) METHODS SYSTEMS AND COMPUTER PROGRAM PRODUCTS FOR APPLYING GENERATED RULES FOR PERSONALIZED INTERVIEW EXPERIENCE

(71) Applicant: Intuit Inc., Mountain View, CA (US)

(72) Inventors: Gang Wang, San Diego, CA (US); Adam Whitney, San Diego, CA (US); Kevin McCluskey, Carlsbad, CA (US); Paul Bober, San Diego, CA (US); George A. Cacioppo, JR., San Diego, CA (US)

(73) Assignee: Intuit Inc., Mountain View, CA (US)

(21) Appl. No.: 14/097,057

(22) Filed: Dec. 4, 2013

(51) Int. Cl. G06Q 40/00

(52) U.S. Cl. CPC G06Q 40/123

(57) ABSTRACT

Methods, systems and computer program products for generating decision and meta rules used for determining which questions to present to a tax preparation application user and determine whether a tax situation or topic is applicable to the user. Decision and meta rule sets are generated for tax topics such that as inputs or answers to questions are received and no generated decision rule can be executed, at least one generated meta rule is execute to invalidate one or more generated decision rules. A next question is selected for presentation to the user based at least in part upon a meta rule involving at least one rule of the subset of potentially executable decision rules. Decision rules, and corresponding questions, are invalidated in response to input and when no decision rule can be executed to reduce user questioning while still making a determination whether a tax situation or topic applies.

### SUMMARY

Embodiments are directed to providing users of tax preparation applications with personalized interview experiences.

Embodiments are directed to determining whether a certain tax situation or topic applies to a user by asking a subset of a set of questions that would normally be asked of the user to reach the same conclusion.

Certain embodiments are directed to generating different kinds of rules that are selectively executed in view of a user's answers to presented questions to invalidate at least one generated rule, eliminate at least one question associated with an invalidated rule, and determine which question to present to a user for determining whether a tax situation or topic applies to the user in view of generated rules that were not invalidated.

Certain embodiments are directed to transforming sequence-dependent data structures into sequence independent rules that can be executed to select various questions for presentation to the user in various sequences based in part upon how the user responds to questions rather than being constrained or limited by pre-determined sequences of sequence dependent data structures.

Certain embodiments are directed to eliminating or invalidating rules that are generated according to embodiments when user inputs or answers provided by the user are insufficient to execute a generated rule to make a determination or conclusion regarding whether a tax topic or question applies to the user, thus reducing the number of generated rules that may be subsequently selected for execution to determine whether a tax situation or topic applies to a user of a tax preparation application.

Certain embodiments are directed to executing multiple transformations of representations of questions and answers pertaining to a tax situation or topic in order to generate multiple rule sets. Generated rule sets are used to eliminate questions that can be asked, select a question from a set of remaining questions based on application of generated rules, leading to eventual execution of a generated rule that results in a determination of whether the tax situation or topic applies to the user.

Certain embodiments are directed to generating personalized interview experiences for users of a tax preparation application utilizing generated decision rules and generated meta rules based on or derived from generated decision rules. A decision rule generated according to embodiments comprises or specifies elements, inputs, operands or conditions that must be satisfied before that decision rule can be executed to make a determination whether a tax situation or topic is applicable to the user. Meta rules are rules about or derived from the decision rules. Meta rules may be used to invalidate decision rules such that corresponding questions are not available to be selected for presentation to the user, and identify which elements are required for a decision rule to execute in order to determine which question to select for presentation to the user.

Certain embodiments are directed to generating personalized interview experiences for users of a tax preparation application by employing a rule-based method and system in which one or more rules and are invalidated such that at least one question that would normally be presented to the user according to a pre-determined sequence (e.g., according to a pre-defined tree structure or flow chart utilized by the tax preparation application) is not presented to the user.

Certain embodiments are directed to generating multiple rule sets including decision and meta rule sets, each metal rule set including at least one meta rule utilized to invalidate at least one decision rule such that a question corresponding to the invalidated decision rule that would normally be presented to the user according to a pre-determined order or sequence (e.g., of a tree structure or flow chart) is not presented to the user. According to embodiments, if a decision rule is not executed, it may be invalidated and eliminated from subsequent consideration by a meta data rule to narrow or focus which decision rule should be selected and executed next. Rule execution, decision rule invalidation, selection of the next rule and execution of the next rule can be repeated as additional user input is received until a remaining decision rule is eventually executed resulting in determining whether a tax situation or topic applies to the user.

The sequence of questions selected utilizing rules generated according to embodiments may be different compared to the sequence of questions specified by a pre-determined sequence of questions of a fixed or static tree structure, a flow chart or a directed graph based thereon. Further, according to embodiments, certain generated rules may be executed to invalidate or eliminate at least one other generated rule and eliminate one or more questions that would have otherwise been asked of the user according to the pre-determined sequence. Thus, embodiments may involve asking only certain questions reflected in the tree structure, flow chart or directed graph, and doing so in a sequence that differs from pre-determined sequences defined by those data structures. This may be due to one or more generated rules being executed to eliminate or skip over one or more questions that would have otherwise been presented to the user according to a pre-determined sequence.

Embodiments provide for transforming data structures defining pre-determined sequences of questions and answers into independent rules used to generate rules and that can be used to select various questions in various sequences so as to not be constrained by pre-determined sequences from which they were derived. Further, by executing certain generated rules to invalidate certain other generated rules, the scope of questions associated the remaining subset of potentially executable rules is reduced or narrowed.

One embodiment is directed to a computer-implemented method for generating a personalized interview experience for a user of a tax preparation application for determining whether a tax return topic applies to the user. The method comprises a computer receiving first user input in response to a first question presented to the user and determining whether at least one generated rule of a first rule set is executable utilizing the first user input in order to determine whether the tax return topic is applicable to the user. When no generated rule of the first rule set can be executed using the first user input, at least one generated rule of the first rule set is invalidated by executing of at least one generated rule of another rule set. Otherwise, when at least one generated rule of the first rule set can be executed, that generated rule is executed to determine whether the tax return topic is applicable to the user.

A further embodiment is directed to a computer-implemented method for generating a personalized interview experience for a user of a tax preparation application for determining whether a tax topic applies to the user and comprises generating a plurality of decision rules. Decision rules are based at least in part upon a first representation of questions pertaining to the tax return topic. Execution of each decision rule generates a result indicative of whether the tax topic applies. A plurality of meta-level rules is generated based at least in part upon the plurality of decision rules. The method further comprises the computer determining whether at least one decision rule can be executed based on a first user input provided in response to a first question presented to the user. When no decision rule can be executed based on the first user input, the computer executes at least one meta rule to invalidate at least one decision rule thereby resulting in a first subset of decision rules, and determining a second question to select and present to the user based at least in part upon at least one other meta rule involving at least one decision rule of the subset. Otherwise, the at least one decision rule is executed to determine whether the tax topic applies to the user.

A further embodiment is directed to a computer-implemented method for generating a personalized interview experience for a user of a tax preparation application for determining whether a tax topic applies to the user and comprises a computer generating a first rule set based at least in part upon a first representation of questions pertaining to the tax topic. The method further comprises the computer generating second and third rule sets based at least in part upon the generated first rule set. The method further comprises the computer receiving a first user input in response to a first question presented to the user and determining whether any rule of the first rule set can be executed based on the first user input. If not, at least one rule of the second rule set to invalidate at least one rule of the first rule set, thereby resulting in a first subset of the first rule set. The method further comprises the computer determining a second question to present to the user based at least in part upon at least one rule of the third rule set involving at least one rule of the first subset. Otherwise, when it is determined that a rule of the first rule set can be executed, that rule is executed and generates a result indicative of whether the tax topic applies to the user.

Other embodiments are directed to articles of manufacture or computer program products comprising a non-transitory computer readable medium comprising one or more instructions which, when executed by a computer, causes the computer to execute a process for generating a personalized interview experience for a user of a tax preparation application for determining whether a tax topic applies to the user.

Yet other embodiments are directed to systems for determining which questions to present to a user of a tax preparation application or determining whether a tax topic applies to the user. System embodiments may comprise or involve a computer configured to execute method embodiments, by execution of a personalization module that is in communication with an interface manager, a rule engine and one or more data stores for a fact cache for storing user input or responses and generated rules. For example, the personalization module is configured to generate a first rule set, or a decision rule set, based at least in part upon a first representation of questions pertaining to the tax topic. The first representation may be a decision table derived from or based on a directed graph, which is derived from or based on a flow chart of questions and answers for a tax situation or topic. The personalization module also generates a second rule set and a third rule set, both of which are meta rule sets, based at least in part upon the generated first rule set. The personalization module is configured to present questions selected by execution of generated rules and receive answers from the user of the tax preparation application. The personalization module is also configured to process user inputs or answers to determine whether any decision rule of the first rule set can be executed based on the first user input. If not, the rule engine executes at least one rule of the generated second rule set to invalidate at least one rule of the generated first rule set resulting in a first subset of the first rule set. The personalization module is configured to determine a second question to present to the user based at least in part upon at least one rule of the third rule set involving at least one rule of the first subset. Otherwise, when a decision rule of the first rule set can be executed, the rule engine executes that rule and generates a result indicating whether the tax topic applies to the user.

In a single or multiple embodiments, the first representation utilized to generate the plurality of decision rules is a decision table. Each decision rule is executable to generate a result indicating whether the tax topic applies to the user. According to one embodiment, respective rules of the first rule set are based on respective rows of the decision table. A generated rule of the first rule set is generated for each row of the decision table such that a number of rows in the table may be the same as a number of rules in the first rule set.

The decision table may be received by the computer or rule invalidation module and subsequently processed, or generated thereby, e.g., based at least in part upon a second representation of questions pertaining to the tax topic such as a directed graph. In the directed graph, which may also be generated by the computer, a beginning node and intermediate nodes correspond to respective questions, inter-node connections correspond to respective answers to respective questions, and a terminal node of the directed graph is a result node indicating whether the tax topic applies to the user. The directed graph may be derived from or based at least in part upon a third representation of questions pertaining to the tax topic such as a flow chart. The flow chart includes a pre-determined, static sequence of questions or decision blocks and respective answers. Beginning and intermediate nodes of the directed graph are based on respective questions or decisions blocks of the flow chart, and respective connections of the directed graph are based on respective answers to respective questions or decision blocks of the flow chart.

In a single or multiple embodiments, each rule of the selected first subset following invalidation of at least one rule of the first rule set is a rule that cannot be executed based only upon inputs received thus far, but may potentially be executed later based at least in part upon the received first user input and at least one other user input.

In a single or multiple embodiments, the second generated rule set and the third generated rule set, as meta data rules about the generated first rule set, do not include any rule that is executable to generate a result indicating whether the tax topic applies to the user. The second rule set comprises a first meta data rule set based at least in part upon the first rule set, and the third rule set comprises a second meta data rule set based at least in part upon the first rule set.

In a single or multiple embodiments, rules of the first meta rule set are based at least in part upon inverses of respective elements of respective rules of the first rule set. According to embodiments, the computer parses rules of the first rule set to determine respective elements of respective rules of the first rule set, or the inputs required in order for respective rules of the first rule set to execute. For each element of each rule of the first rule set, the inverse of the element is determined, and each rule of the first meta rule set specifies how at least one rule of the first rule set is invalid based at least in part upon at least one determined inverse. According to one embodiment, each rule of the first meta rule set or second rule set involves an inverse of a single element, which may be used to invalidate one or multiple decision rules, or rules of the first rule set. In the context of the table upon which rules of the first rule set or based, execution of a rule of the first meta rule sets results in “crossing out” rows of the decision table based on or derived from the directed graph.

In a single or multiple embodiments, rules of the second meta rule set or third rule set, indicate which inputs are needed in order for respective rules of the first rule set to be valid and executable.

In a single or multiple embodiments, generated rules are used to select which questions to present to a user and eventually lead to execution of a decision rule that generates a result that indicates whether a tax topic is applicable to the user, such as whether the user qualifies for a tax deduction or a tax credit. The result of execution of a decision rule may also indicate that a subsequent action should be executed, such as populating a tax form with data of answers previously received, determining which interview screens to present to the user so that the user can then be presented with all of the questions regarding the determined tax topic. Thus, embodiments may be used to determine which tax topic applies, and then initiate presentation of a pre-determined sequence of interview screens of the tax preparation application that include other, more detailed questions about that tax topic. Thus, with embodiments, certain tax topics may be eliminated by having the user answer a small number of questions rather than requiring the user to answer a larger number of questions and/or complete other forms or worksheets in order to reach the same conclusion. Execution of a decision rule indicating that a tax topic applies may also result in notifying the user that a different version of the tax preparation application should be utilized.

In a single or multiple embodiments, as additional questions are presented to the user and additional answers or user inputs are received, so long as no rule of the first rule set is executed utilizing the received inputs or answers, the computer continues to determine whether any rule of the first subset can be executed based on received inputs thus far. Each time a rule of the first subset cannot be executed, at least one rule of the second rule set is executed to invalidate at least one rule of the first subset resulting in a further, more refined, smaller subset of the first rule set, and determining a subsequent question to present to the user based at least in part upon at least one rule of the third rule set involving at least one rule of the more refined, smaller subset.

In a single or multiple embodiments, rules are generated for a tax topic as summarized in a flow chart, and multiple transformations result in generation of rules of the first rule set for each tax topic and generation of meta rules for each tax topic.

In a single or multiple embodiments, a sequence of questions determined by application of generated rules is different compared to sequence specified by a representation such as a flow chart from which certain generated rules were indirectly derived. Further, the sequence of questions may be different compared to a pre-determined sequence of questions programmed within the tax preparation application for that tax return topic. Moreover, according to embodiments utilizing generated rules, the sequence of questions may be different compared to a pre-determined sequence of questions specified by paths through a directed graph derived from the flow chart, and from which decision rules are determined. Moreover, questions within a directed graph path may be eliminated according to embodiments. Embodiments are operable to skip questions within a directed graph path, and the sequence of questions that is eventually generated is not pre-determined, unlike a flow diagram or paths through a directed graph defining a pre-determined sequence.

### BRIEF DESCRIPTION OF THE DRAWINGS

The foregoing and other aspects of embodiments are described in further detail with reference to the accompanying drawings, in which the same elements in different figures are referred to by common reference numerals, wherein:

FIG. 1 is a flow diagram of one embodiment of a method for providing a personalized interview experience by generating rules;

FIG. 2 is a flow diagram of another embodiment of a method for providing a personalized interview experience and that involves generating rules and transforming or converting data structures representing questions and possible answers to questions;

FIG. 3 is a flow diagram of one embodiment of a method for providing a personalized interview experience by generating decision and meta rules and executing generated rules to invalidate one or more generated decision rules;

FIG. 4 is a block diagram of an embodiment of a system configured for providing a personalized interview experience;

FIG. 5 is a block diagram showing additional components of an embodiment of a system configured for providing a personalized interview experience;

FIG. 6 is a system flow diagram generally illustrating transformations or conversions from a flow chart to a directed graph to a decision table;

FIG. 7 is a flow diagram of one embodiment of a method for providing a personalized interview experience by generating decision rules and multiple sets of meta rules based on generated decision rules;

FIGS. 8A-C illustrate examples of flow charts for tax topics involving whether a child or person is a qualifying child or qualifying person for purposes of determining whether a user would qualify for exemptions, deductions or credits;

FIG. 9 illustrates an example of a directed graph based on or derived from a flow chart and that can be utilized according to embodiments;

FIG. 10 illustrates an example of a decision table based on or derived from the directed graph shown in FIG. 9 and that can be utilized according to embodiments;

FIG. 11A illustrates examples of decision rules generated according to embodiments based on or derived from a data structure such as a decision table; FIG. 11B illustrates examples of meta rules generated according to embodiments and based on inverses of elements of generated decision rules for use in decision rule invalidation, and FIG. 11C illustrates examples of meta rules generated according to embodiments and based on inputs required to satisfy elements or conditions of generated decision rules;

FIG. 12 is a flow diagram of one embodiment of a method for providing a personalized interview experience by generating decision rules and multiple sets of meta rules based on generated decision rules and illustrating how certain generated decision rules can be invalided by execution of generated meta data rules when a generated decision rule cannot be executed;

FIG. 13 is a flow diagram illustrating how processing of generated decision rules and meta rules can be repeated as necessary when no generated decision rule can be executed;

FIG. 14 illustrates an example of a decision table showing how rows thereof can be crossed out based on invalidation of one or more generated decision rules;

FIG. 15 illustrates an example of how embodiments may be implemented to invalidate or eliminate generated decision rules and how many generated decision rules may potentially be executed;

FIG. 16 illustrates examples of answers or responses provided by a user and resulting questions that can be selected for presentation to the user according to embodiments as a result of the subset of generated decision rules remaining after other generated decision rules have been invalidated;

FIG. 17 is a system flow diagram further illustrating how embodiments may be used to invalidate decision rules that were generated and to narrow the scope of associated questions to be selected for presentation to a user;

FIG. 18 generally illustrates how embodiments may be executed to provide personalized interview experiences of users of a tax preparation application; and

FIG. 19 is a block diagram of a computing apparatus or system in which various embodiments may be implemented or that may be utilized to execute various embodiments.

### DETAILED DESCRIPTION OF ILLUSTRATED EMBODIMENTS

Embodiments are directed to providing users of tax preparation applications personalized interview experiences and determining whether a certain tax topic applies to a user by asking a subset of a set of questions that would normally be asked of the user to reach the same conclusion. Embodiments transform pre-determined sequences of questions and answers generated by tax preparation applications, which may be in the form of flow diagrams, into expressions of rules generated according to embodiments and executed to select questions to present to users of a tax preparation application to provide a personalized user experience. Thus, rather than requiring a user to step through each question of a pre-determined sequence of questions in order to conclude that a particular tax situation or topic applies to the user, embodiments can eliminate pre-determined sequence constraints and reach the tax topic conclusion while invalidating generated rules in order to eliminate corresponding questions, even when those questions would have otherwise been asked of the user according to the pre-determined sequence.

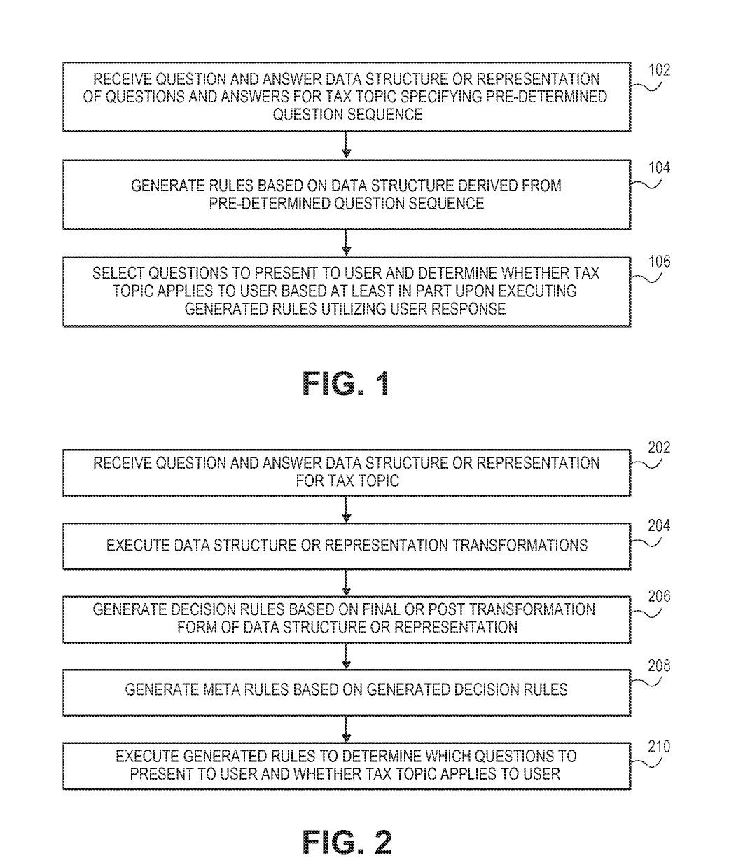

For example, referring to FIG. 1, in a computer-implemented method according to one embodiment, at 102, a structure or representation of a pre-determined sequence of questions and answers for a tax situation or topic, e.g., as generated by the tax preparation application or provided by another source, is received by a personalization module. At 104, the personalization module generates rules based on a data structure derived from the pre-determined question sequence. At 106, questions to present to user to determine whether a tax topic applies to user are selected based at least in part upon user inputs or responses to certain questions and execution of generated rules.

As another example, referring to FIG. 2, in another embodiment of a computer-implemented method, at 202, a personalization module receives a question and answer data structure or representation of questions and answers for a tax situation or topic, and at 204, executes data structure or representation transformations. At 206, decision rules are generated based on a final or post-transformation form of the data structure or representation, and at 208, meta rules are generated based on the generated decision rules. At 210, generated decision and meta rules are executed to determine which questions to select to present to the user and whether a tax topic applies to the user.

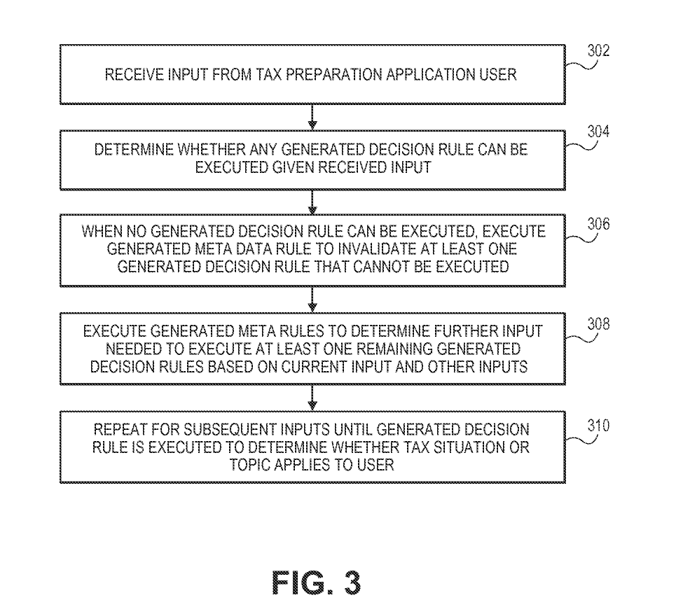

Referring to FIG. 3, in a further embodiment, a computer-implemented method involves receiving input from a user of a tax preparation application at 302, and at 304, determining whether any generated decision rule can be executed given the received user input. If not, then at 306, a generated meta rule is executed, which may invalidate at least one generated decision rule, thus resulting in a subset of generated decision rules. At 308, a generated meta rule is also executed to determine which inputs are required to allow remaining decision rules to execute and to determine questions to be selected to present to the user in order to determine these inputs. At 310, execution of decision rules and execution of metal rules to invalidate a decision rule and determine which inputs are required are repeated as necessary in response to answers or inputs received by the user until a generated decision rule is eventually executed to determine whether tax situation or topic applies to user.

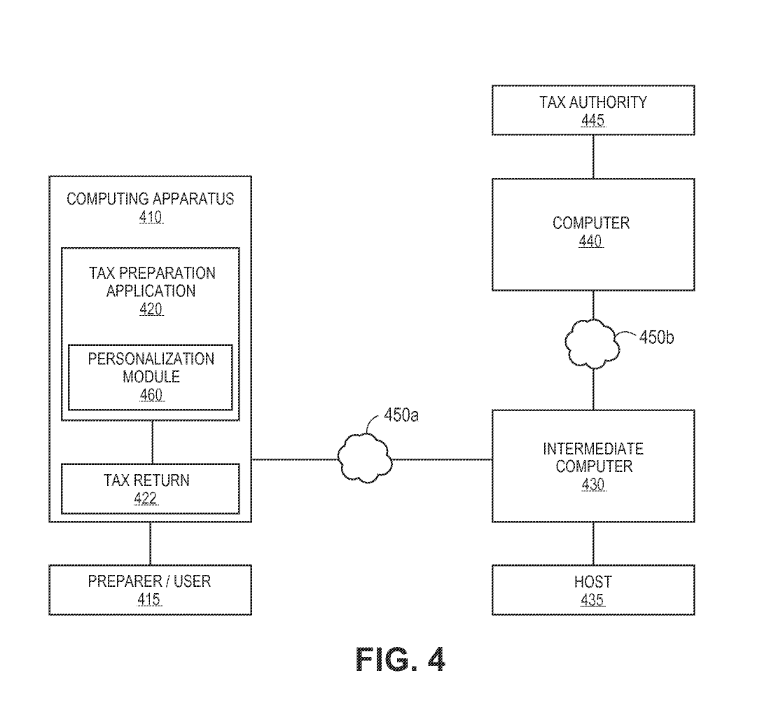

With embodiments, decision and meta rules are generated indirectly from an initial flow chart or pre-determined sequence and are used to invalidate certain decision rules and eliminate associated questions, while selecting more relevant questions without constraints or restrictions of the initial pre-determined sequence. Thus, embodiments provide for intelligent question guidance while being flexible, dynamic and adaptive to user input or answers and narrowing the field of potential generated rules that may be utilized and questions that may be presented to the user. Embodiments and aspects thereof are in further detail with reference to FIGS. 4-19.

Referring to FIG. 4, a system configured or constructed according to one embodiment comprises or involves a computer, computing device or communication device 410 (generally, user computer 410) of a user, taxpayer, accountant or tax professional 415 (generally, user 415). The user utilizes a tax preparation application 420 such as TURBOTAX tax preparation application. The tax preparation application 420 is operable to prepare an electronic tax return 422. In the illustrated embodiment, the user computer 410 is in communication with one or more intermediate computers 430 (one intermediate computer 430 is illustrated for ease of explanation) of one or more hosts 435, which is in communication with a computer 440 of a tax authority 445. The taxpayer computer 410 is in communication through a network 450a with the intermediate computer 430, which may also be an electronic filing server operable to electronically file electronic tax returns with the tax authority computer 440 and which is in communication through a network 450b with the tax authority computer 440. Each of the networks 450a-b (generally network 450) may be different, or two or more networks 450 may be the same depending on the system configuration and communication protocols employed. One or more or all of the networks 450 may be, for example, a cellular network, a wireless network, a Local Area Network (LAN) and/or a Wide Area Network (WAN) or a combination of two or more networks. Reference to a network 450 generally is not intended to refer to a specific network or communications protocol, and it should be understood that embodiments can be implemented using various networks and combinations thereof.

Reference is made generally to a user 415, but it will be understood that the user 415 may be a taxpayer preparing his or her own electronic tax return 422 or another user 415 preparing the electronic tax return 422 on behalf of the taxpayer. The user computer 410 may be a desktop or laptop computer or other computing or communication device such as a tablet computing or communication device or mobile communication device such as a smartphone (generally, computer or computing apparatus 410) executing the tax preparation application 420.

In the illustrated embodiment, the tax preparation application 420 is a desktop version that executes on the user computer 410, but embodiments may also involve an online version of the tax preparation application 420 (e.g., turbotax.com), which is hosted by the intermediate computer 430 or another computer of the host 435 and accessible by a browser executing on the user computer 410. The tax preparation application 420 can be executed to navigate interview screens and enter or import tax data from an electronic file or source into the interview screen fields, to eventually complete the electronic tax return 422. The intermediate computer 430, or another intermediate computer serving as an electronic filing server or clearing house, formats and electronically files the completed electronic tax return 422 with the tax authority computer 440. The intermediate computer 430 processes acknowledgements and other data received from the tax authority 445 and routes related information back to the taxpayer computer 410. One example of an intermediate computer 430 or electronic filing server that may be utilized for these purposes is an electronic filing server of Intuit Inc., Mountain View, Calif.

For purposes of this application, a tax preparation application 420 is defined as a computer program product, or system, that is used solely for preparing a tax or information return or other tax filing 422 (generally, electronic tax return 422), and that may be operable to record, transmit, transfer and organize data related to such tax filings, and that enable users or taxpayers 415 to file income tax returns or assist them with managing their finances or tax-related matters. Examples of tax preparation applications 422 include consumer and professional tax preparation applications 420 available from Intuit Inc., Mountain View, Calif., one example of which is TURBOTAX tax preparation application. It should be understood that embodiments may utilize or be incorporated into other tax preparation applications 422, and that reference to TURBOTAX tax preparation application is provided as a non-limiting example.

The tax authority 445 with which tax returns 422 are filed may be a federal tax authority such as the Internal Revenue Service (IRS), a state tax authority such as the State Franchise Board of California or other tax collecting entity to which taxes are paid. For ease of explanation, reference is made generally to a tax authority 445, and examples involve the IRS, but it will be understood that tax authority 445 refers to various tax collecting entities, including local, state and federal tax collecting entities.

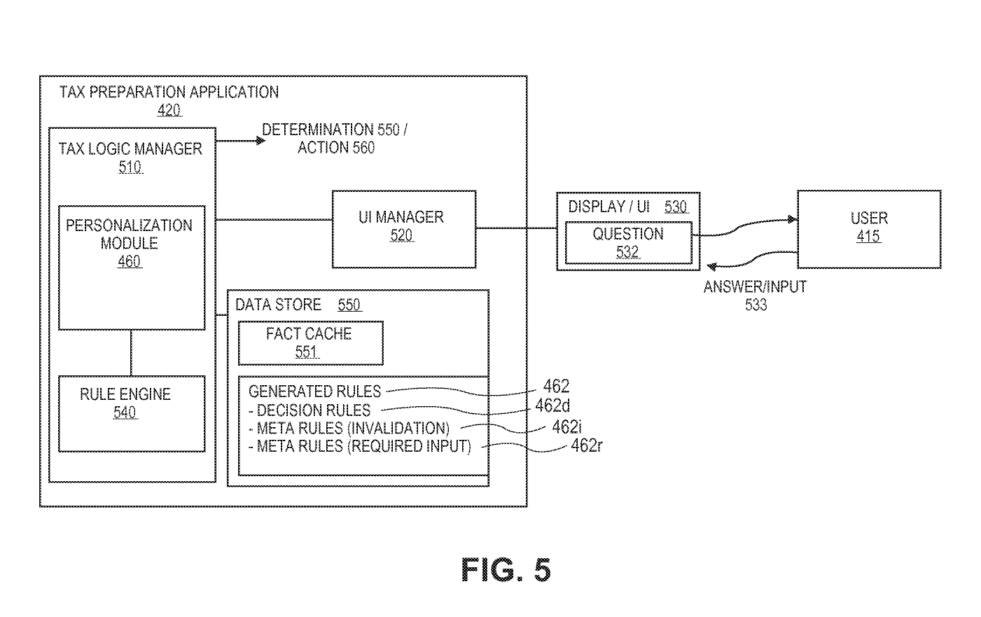

As shown in FIG. 4 and with further reference to FIG. 5, the tax preparation application 420 includes, or is in communication with, a personalization module 460 according to embodiments. In the illustrated embodiment, the tax preparation application 420 includes a tax logic manager 510 and a user interface (UI) manager 520. The tax logic manager 510 is configured to determine which tax situations or topics are relevant to the user 415, which questions should be selected to ask the user 415, and the order or sequence of such questions. The tax logic manager 510 communicates with the UI manager 520, which is configured or operable to generate a display, screen or user interface (UI) 530 for presenting selected questions 532 to the user 415 and receive user input or answers 533. User input or answers are communicated back to components of the tax logic manager 510 for processing.

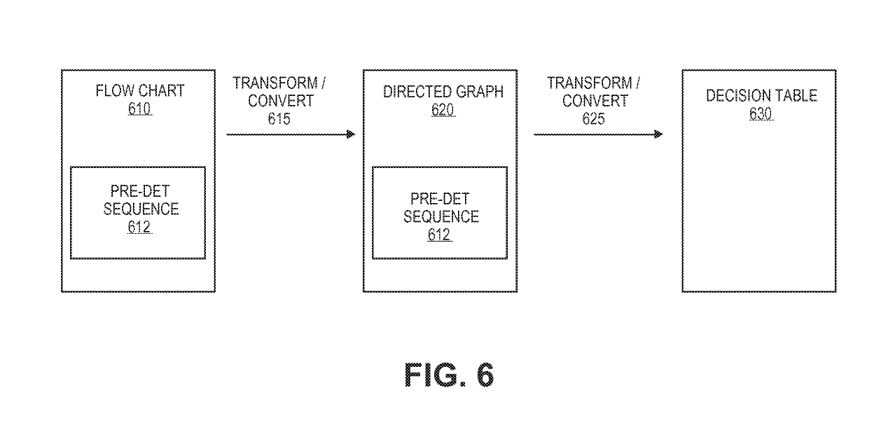

As generally illustrated in FIG. 4, the tax logic manager 510 comprises, involves or communicates with the personalization module 460, a rule engine or rule execution module (generally, rule engine 540) and also includes, or is in communication with, one or more data stores or databases 550 (generally, data store 550). The data store 550 may be utilized according to embodiments for storing user responses or answers 533 (e.g., within a “fact cache” 551 as illustrated in FIG. 5) and rules 462 that are generated by the personalization module 460 according to embodiments as described in further detail below. Aspects of embodiments with reference to system components described above are described in further detail with reference to FIGS. 6-19.

According to embodiments, the personalization module 460 generates rules 462 that are executed based at least in part upon user answers or input 533, to eliminate or invalidate certain generated rules 462 rules and determine which questions 532 should be selected for presentation to the user 415. According to one embodiment, rules 462 are generated following multiple transformations of a data structure or representation of a pre-determined sequence of questions 532 and answers 533.

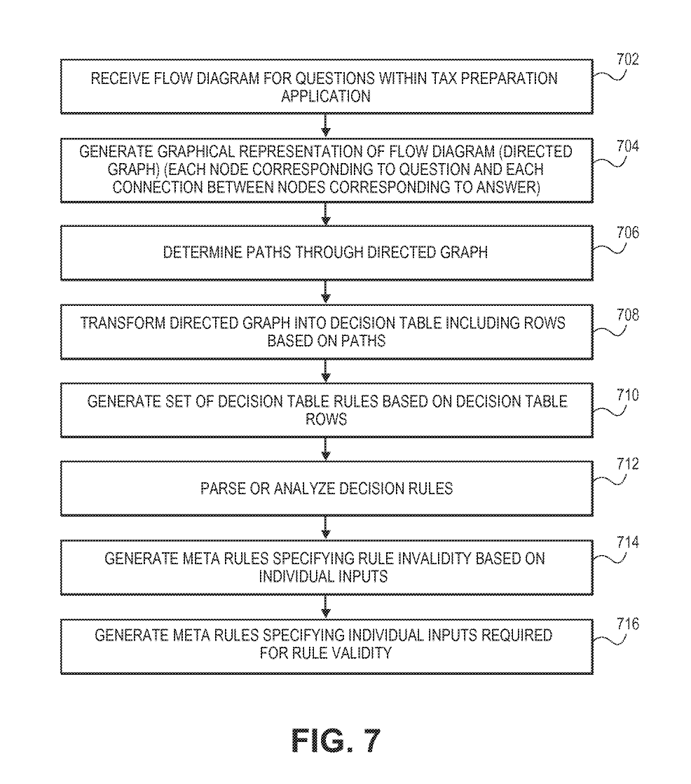

For example, according to one embodiment, as generally illustrated in FIGS. 6 and 7, embodiments may begin with the computer generating or receiving, at 702, a flow chart 610 including a pre-determined sequence 612 of questions and answers for determining whether a particular tax topic applies to the user 415.

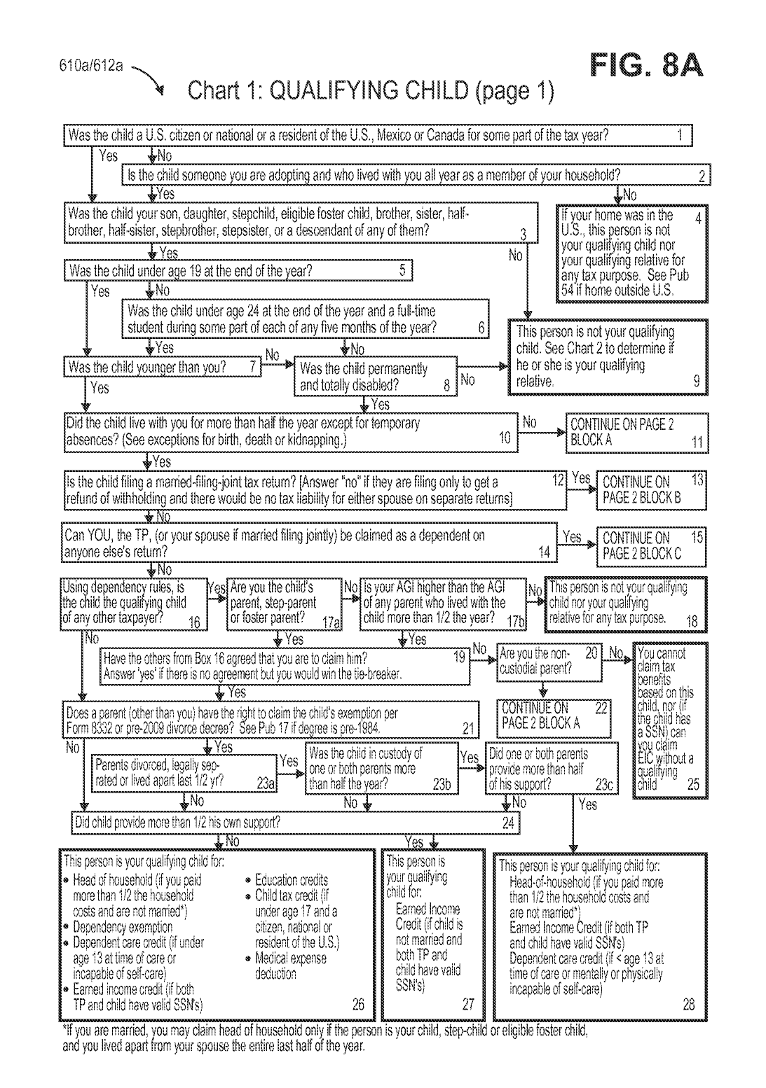

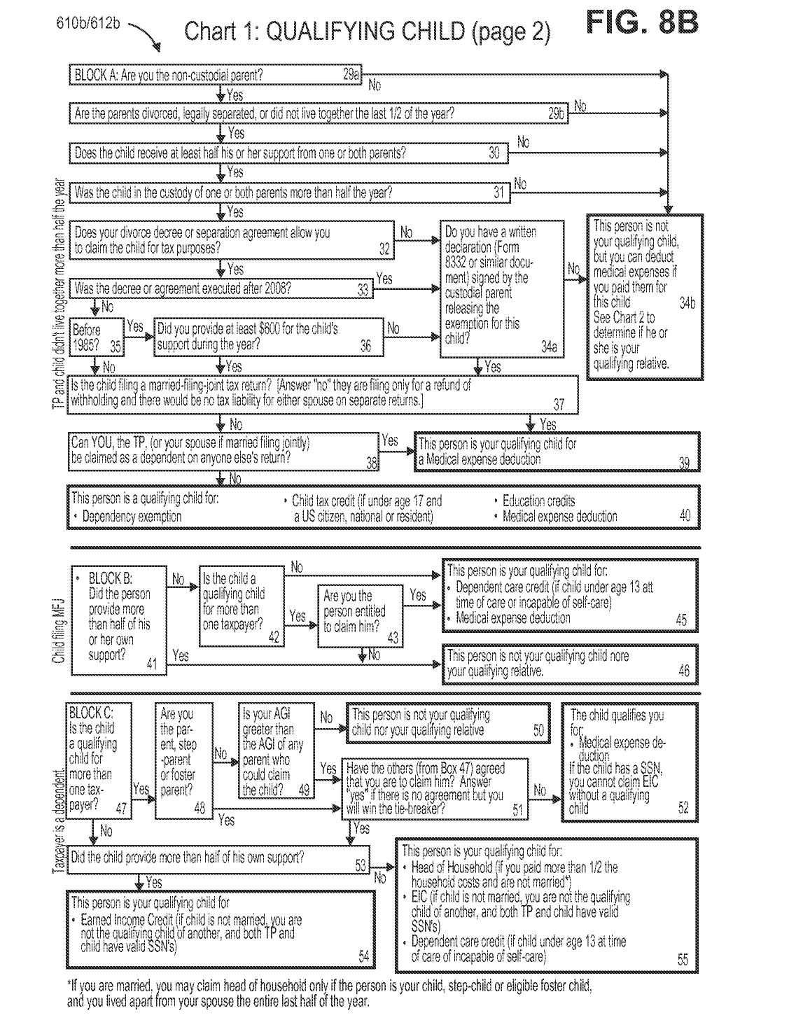

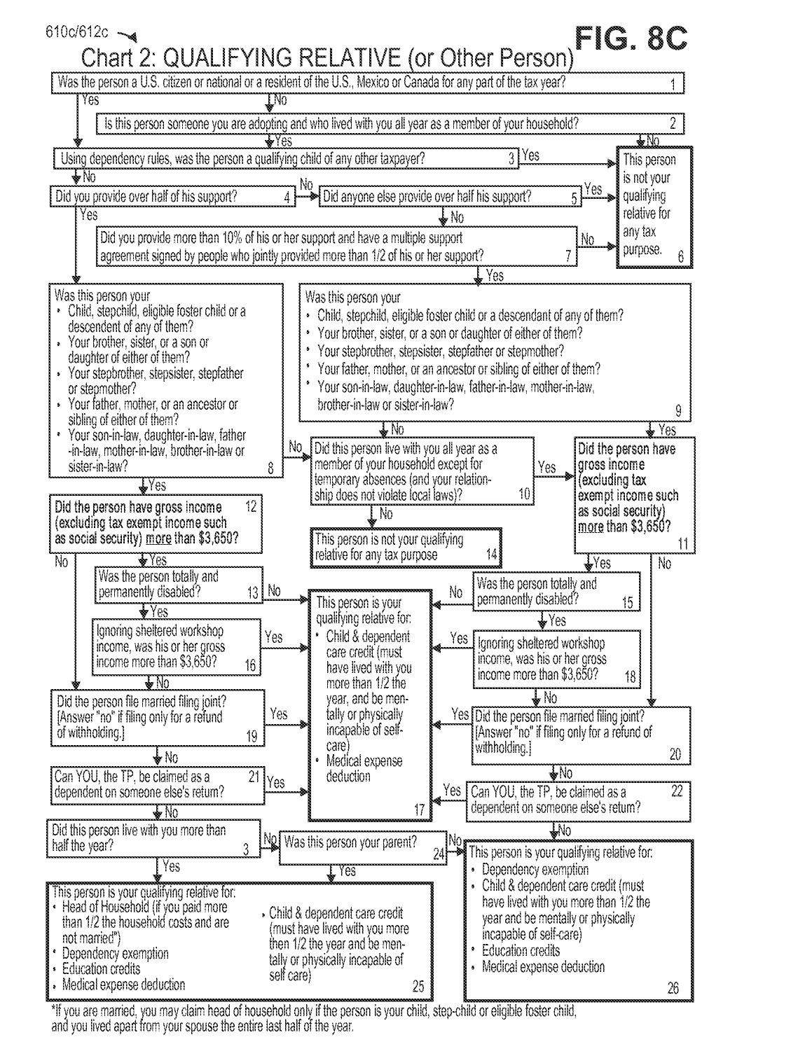

FIGS. 8A-C illustrate examples of flow charts 610a-c and how they are structured with pre-determined sequences 612a-c (generally, pre-determined sequence 612) of questions concerning tax topics such as whether a user's child is a “qualifying child” or whether a person is a “qualifying relative” for considering eligibility for various income tax deductions, tax credits and exemptions such as dependency exemption, earned income credit, and medical expense deductions. As shown in the exemplary flow charts 610a-c (generally, flow chart 610) of FIGS. 8A-C, particular questions are asked in a fixed, pre-defined sequence in order to reach a conclusion or determination such as the person is a qualifying child or a qualifying relative for various tax matters. It will be understood that embodiments may involve one or multiple flow charts, and such flow charts may involve one or multiple tax topics. For ease of explanation, not limitation, reference is made generally to a flow chart 610 and pre-determined sequence 612 of questions thereof.

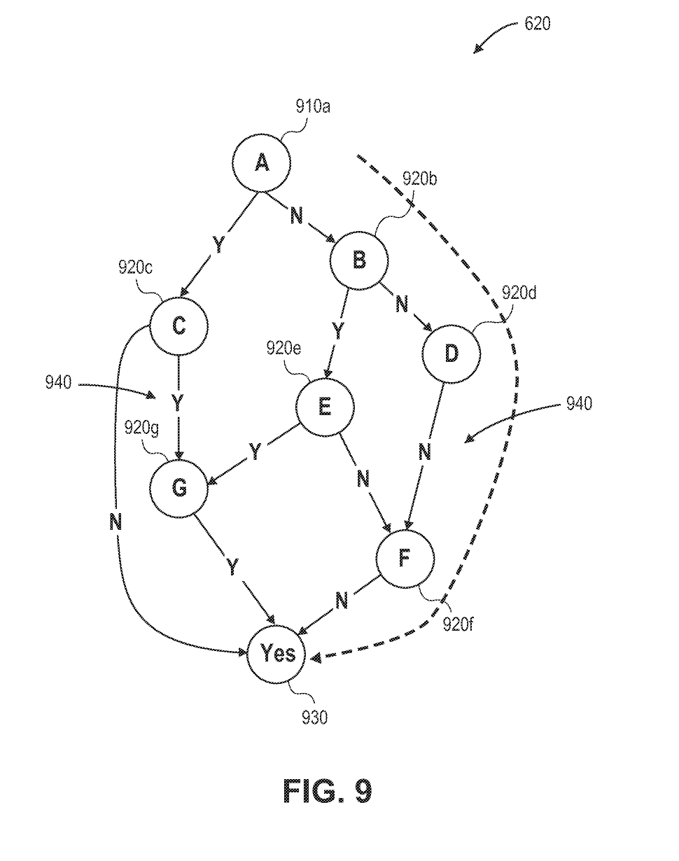

Referring again to FIGS. 6-7 and with further reference to FIG. 9, at 704, the flow chart 610 is transformed or converted 615 into a different format, such as a graphical representation of the flow chart 610. In the illustrated embodiment, this is in the form of a directed graph 620. FIG. 9 generally illustrates an example of a directed graph 620, and is illustrated in a simplified form compared to the more complex flow charts 610 and pre-determined sequences 612 thereof illustrated in FIGS. 8A-C for ease of explanation and illustration. It will be understood that embodiments may involve generation of a directed graph 620 based on the flow charts 610a-c shown in FIGS. 8A-C, as well as for other tax topics, such that the simplified directed graph 620 shown in FIG. 9 is provided for ease of explanation and illustration.

In the illustrated example shown in FIG. 9, the directed graph 620 includes a beginning node 910a (Node A), intermediate nodes 920b-f (Nodes B-F) and a termination node 930 (Node “Yes”). Each of the beginning node 910a and intermediate nodes 920b-f represents a question. Inter-node connections 940 represent response options. In the illustrated embodiment, each inter-node connection 940 represents an answer or response option in binary form (Y/N). It will be understood, however, that embodiments are not so limited, and that a binary response form is provided as a non-limiting example. In the illustrated example, certain nodes, such as nodes A, B and E, have two response options 940, whereas other nodes, such as nodes C, D, G and F, have one response option 940.

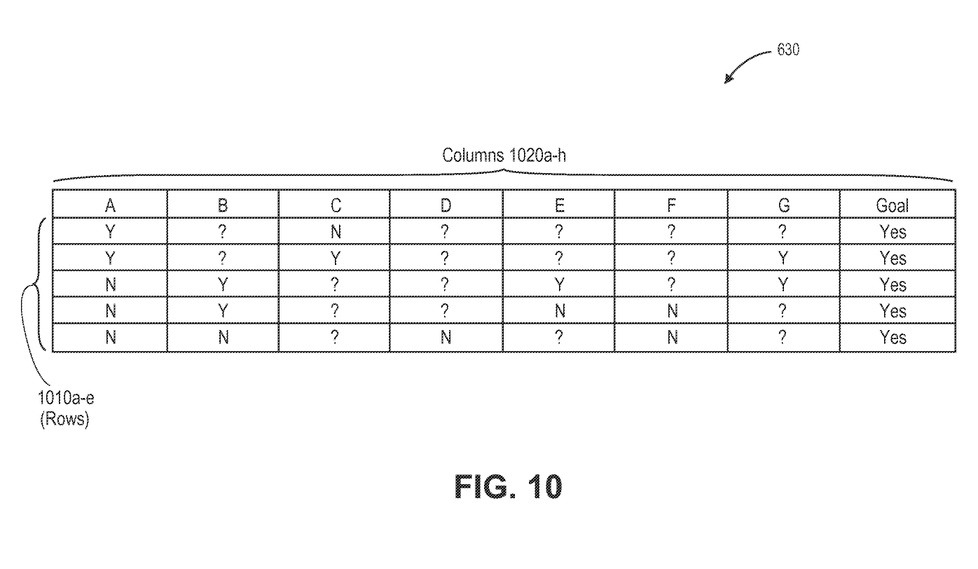

Referring again to FIG. 7 and with further reference to FIG. 10, the personalization module 460 determines possible paths through the directed graph 620 at 706, e.g., by navigating various paths through recursively ensuring that each path from the beginning node 910a to the termination node 930 is determined, and at 708, transforms or converts 625 the directed graph 620 into a different data structure or format. In the illustrated embodiment shown in FIG. 10, this different data structure or format is in the form of a decision table 630. In the illustrated example, the decision table 630 includes rows 1010 (five rows 1010a-e are illustrated) based on the paths through the directed graph 620 determined during step 706. In the illustrated embodiment, the columns 1020a-g of the decision table 630 represent expressions for each of the questions (represented as nodes A-G) and answers derived from paths through the directed graph 620 and column 1020h indicates a conclusion, determination, result or goal concerning a tax topic or situation, e.g., “Yes—your child is a qualifying child.”

Thus, referring to column A, two of the five paths through the directed graph 620 involve “Y” responses to the question for Node A, whereas three of the five paths involve “N” responses to the question for Node A. “Don't care” designations (“?” as shown in FIG. 10) indicate that the answer to a particular question is not needed in order to complete a path through the directed graph 620. Thus, for example, referring to row 1110a, when an answer to Question A is “Y” and a path is completed through the directed graph 620 by answering Question C as “N” then answers to the other questions in Nodes B and E-F are “?” or “Don't Care” since they are not needed to be answered given that particular path. Thus, as shown in the decision table 630, a determination or conclusion that a tax topic applies to the user 415 can be made by traversing various paths of the directed graph 620.

Referring again to FIG. 7, having transformed 615 the flow chart 610 into a directed graph 620, and transformed 625 the directed graph 620 into a decision table 630, at 710, the personalization module 640 generates a set of decision or determination rules 462d (generally, decision rules 462d, “d” indicating “decision”) based at least in part upon the rows 1110 of the decision table 630. Thus, continuing with the example shown in FIG. 10, a decision rule 462d is generated based on each row 1010a-e of the decision table 630. For example, a decision rule 462 may be based on the conclusion of that “Yes” (e.g., the user's child is a “qualifying child”) if the following facts or conditions apply: “A” is answered “Y,” C is answered “Y” and G is answered “Y.” A decision rule 462d is generated for each row 1010 of the decision table 630. Thus, if the decision table 630 has five rows 1010a-e for generation of five decision rules 462d.

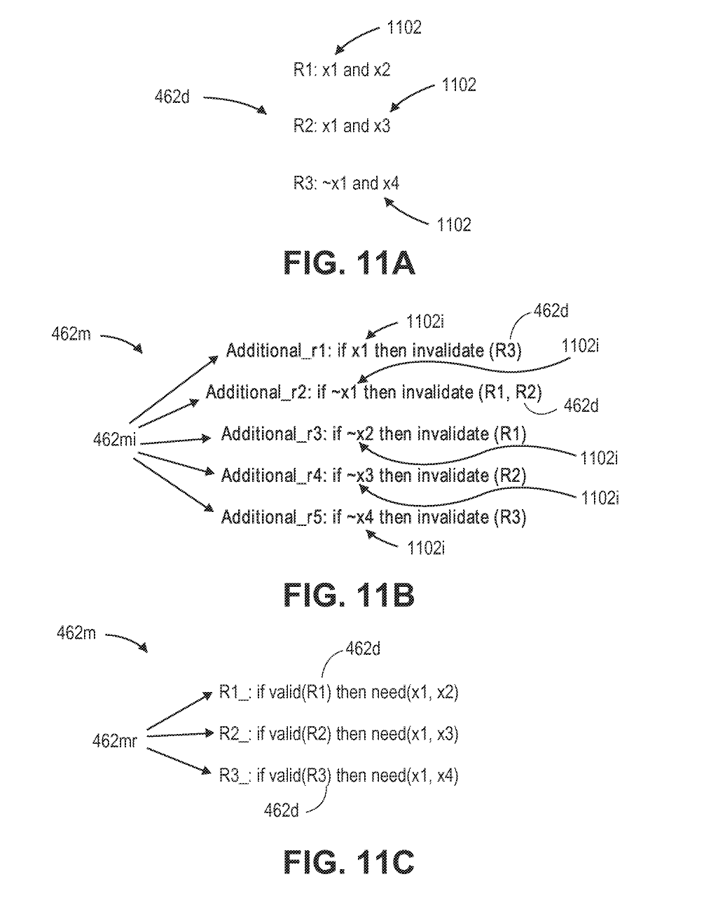

For ease of explanation and illustration, three generic examples of decision rules are provided in FIG. 11A in which independent decision rules 462d “R1,” R2 and “R3” each specify different elements, facts or conditions about the inputs or data required (generally, “element” 1102 of decision rule 462d) in order for the decision rule 462d to fire or execute and to determine whether a tax topic applies to the user 415.

For example, decision rule R1 may specify that a child is a qualifying child (R1) based on elements or facts 1102 (x1 and x2), decision rule R2 specifies that the child is a qualifying child (R2) based on facts or elements 1102 (x1 and x3), and decision rule R3 specifies that the child is a qualifying child (R3) based on facts or elements (˜x1 and x4), in which “˜” in R3 corresponds to “not x1” or the opposite of x1 as recited in R1. Thus, in the illustrated example, different decision rules 462d may involve different elements 1102 and combinations thereof, and may also involve different numbers of elements 1102. Thus, while FIG. 11A illustrates each decision rule 462 including two elements 1102, it will be understood that embodiments are not so limited.

Thus, independent decision rules R1-R3 generated according to embodiments specify three different sets of elements 1102 necessary for the decision rule 462d to execute, resulting in a determination that a particular tax topic applies to the user 415. According to one embodiment, as illustrated, decision rules 462d are derived from respective rows 1010 of the decision table 630, which are based on respective paths through the directed graph 620, which are based on the pre-determined sequences of questions and answers in the flow chart 610. Thus, while generated decision rules 462d are independent of each other and are not tied to or constrained by a pre-determined sequence 612 of questions, they are indirectly based on data structures that specify a pre-determined sequence 612. In other words, embodiments transform sequence-dependent data structures into independent structures in the form of generated decision rules 462d that do not rely upon or specify the pre-determined sequence 612, while still reflecting the substance of corresponding questions and answers of data structures from which they are directly or indirectly based upon as shown in FIG. 6.

Continuing with reference to FIG. 7, at 712, generated decision rules 462d shown in FIG. 11A are parsed or segmented and processed to determine individual elements 1102 and the inverses 1102i (“i” referring to “inverse”) thereof. Thus, for example, decision rule R1 is parsed to determine individual element x1 and individual element x2, and the inverses of these are ˜x1 and ˜x2 respectively. As another example, decision rule R3 is parsed to determine individual element ˜x1 and individual element x4, and the inverses of these are x1 and ˜x4 respectively.

Continuing with reference to FIGS. 7 and 11A-B, at 714, the personalization module 460 generates an additional set rules in the form of meta rules 462m (“m” referring to “meta” rules) based on determined inverses 1102i and that specify when a decision rule 462d is invalid based on these respective determined inverses 1102.

Thus, referring again to FIG. 11A and with further reference to FIG. 11B, meta rules 462m in the form of invalidation rules 462mi (“i” referring to “invalidation” meta rules) specify when a decision rule 462d (as shown in FIG. 11A) is invalid and thus can be eliminated from further consideration as being a decision rule 462d that can never be fired or executed given the required elements 1102 thereof and the user input or answers received thus far. Thus, for example, decision rule R1 species elements “x1 and x2” are necessary such that when a user input or answer is “˜x1” the decision rule R1 will be invalidated due to that decision rule requiring “x1” instead. Similarly, whenever user input or answer is “˜x2” the decision rule R1 will be invalidated due to that rule requiring the opposite. This inversion analysis is performed for each parsed element 1102 of each decision rule 462d, such that in the illustrated example involving three decision rules and five elements or variables (x1, ˜x1, x2, x3 and x4), five meta rules 462m in the form of invalidation meta rules 462mi (“i” referring to “invalidation”) are generated to specify when each of the three decision rules 462d is invalid and can be eliminated from further consideration.

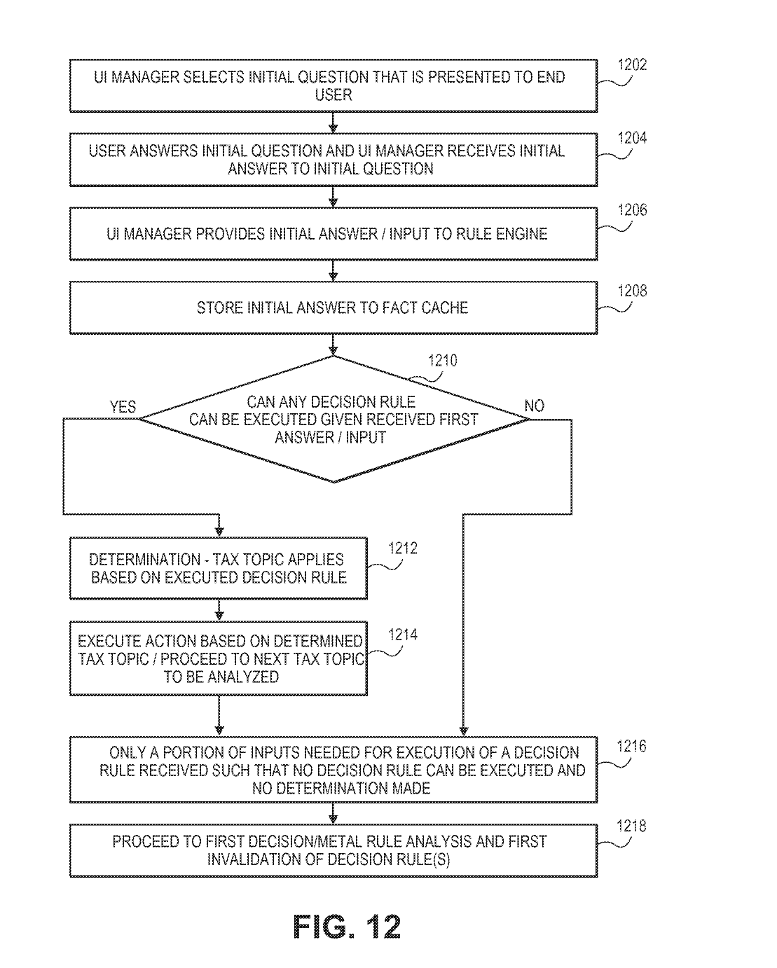

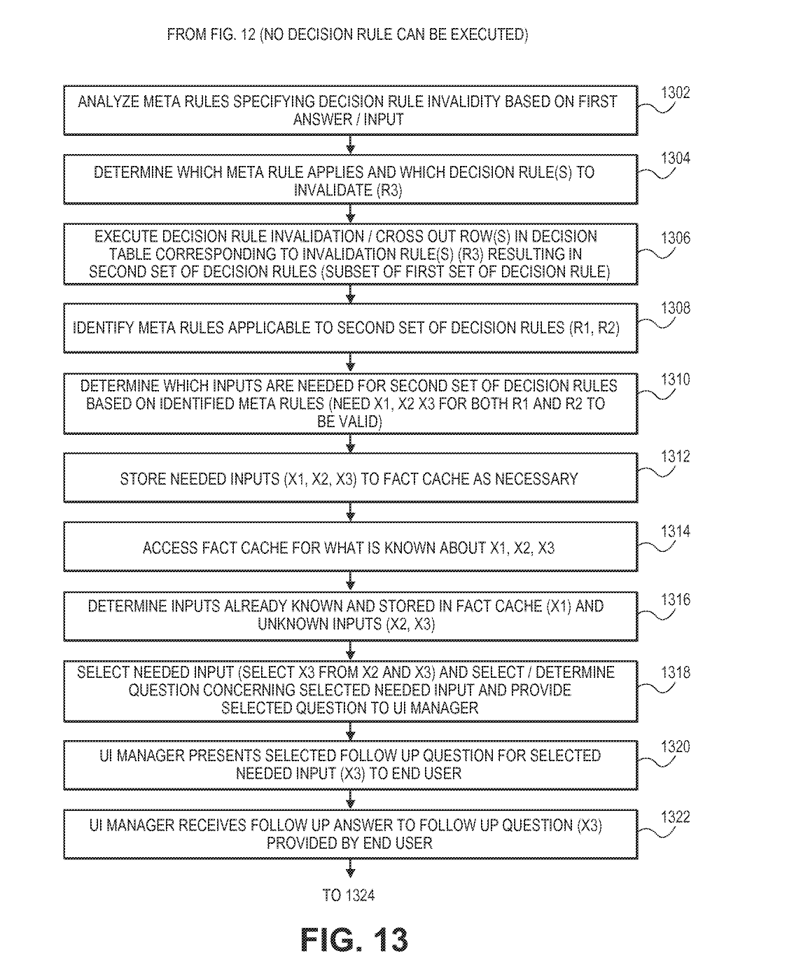

Further, referring to FIGS. 11A and 11C, results of parsing decision rules 462d are also utilized to generate an additional set of meta rules 462m that specify which inputs are required in order to satisfy the decision rule elements 1102 or conditions such that the decision rule 462d can fire or be executed. In the illustrated example, the number of meta rules 462m in the form of meta rules specifying required inputs (462mr, “r” indicating “required” input) is the same as the number of decision rules 462d. Thus, embodiments not only generate decision rules 462d that can be executed to make a determination or conclusion regarding a tax topic, but also two different sets of meta rules 462m (462mi and 462mr) based on or derived from the same set of generated decision rules 462d. Having described how various decision and meta rule sets 462d, 462mi and 462mr can be generated according to embodiments and how they can be executed, further aspects of the decision and meta rules 462d and 462m and how they are processed and executed in order to determine whether a tax topic is applicable to a user 415 are described with reference to FIGS. 12-19.

Referring to FIG. 12 and referring again to FIGS. 4-5, at 1202, an initial question 532 can be selected by the personalization module 460 and presented to the user 415 via the UI manager 520. The initial question 532 may be a pre-determined question or determined based on other information known about the user 415, e.g., from a prior year tax return, user preferences, data already imported or entered into an electronic tax return 422 or based at least in part upon data from another source or utilizing another suitable selection method.

With continuing reference to FIG. 12, at 1204, the user 415 answers 433 the initial question 432 and the answer 433 or fact provided by the user 425 is received by the UI manager 520. At 1206, the answer 433 is provided to the personalization module 460, which stores the received answer 433 to the fact cache 551 at 1208. The rule engine 540 is called to attempt to execute any generated decision rule 462d and determines, at 1210, whether any decision rule 462d can be executed in view of the elements or conditions 1102 thereof and the received answer 533 or fact provided by the user 415.

If so, at 1212, such that the answer 533 is the same as or satisfies all of the elements or conditions 1102 of a decision rule 462d, then the rule engine 540 executes that decision rule 462d using the received input 433 resulting in a determination 550 that the tax topic applies to the user 415. At 1214, a further action 560 may then be executed given the determination 550.

The further action 560 may be, for example, identifying at least one tax form of the electronic tax return 422 pertaining to the tax topic, populating at least one tax form with answers 533 received from the user 415 and any other applicable data that is known, or determining a pre-determined sequence of interview screens or questions of the tax preparation application 520 for the tax topic so that the pre-determined sequence of interview screens or questions can be presented to the user 415 to allow the user 415 to fully respond to all pertinent questions within the interview screens of the tax preparation application 420. Further, depending on the determination 550, a current version (e.g., a basic version) of the tax preparation application 420 may not be suitable to handle the tax topic such that when such the determination 550 is made, the action 460 may be notifying the user 415 that a different version of the tax preparation application 420 should be utilized instead in order to handle the tax topic applicable to the user 415. For example, a basic version of a tax preparation application 420 may not be suitable for situations involving rental properties or sole proprietorships and a more advanced or “premier” version may be required.

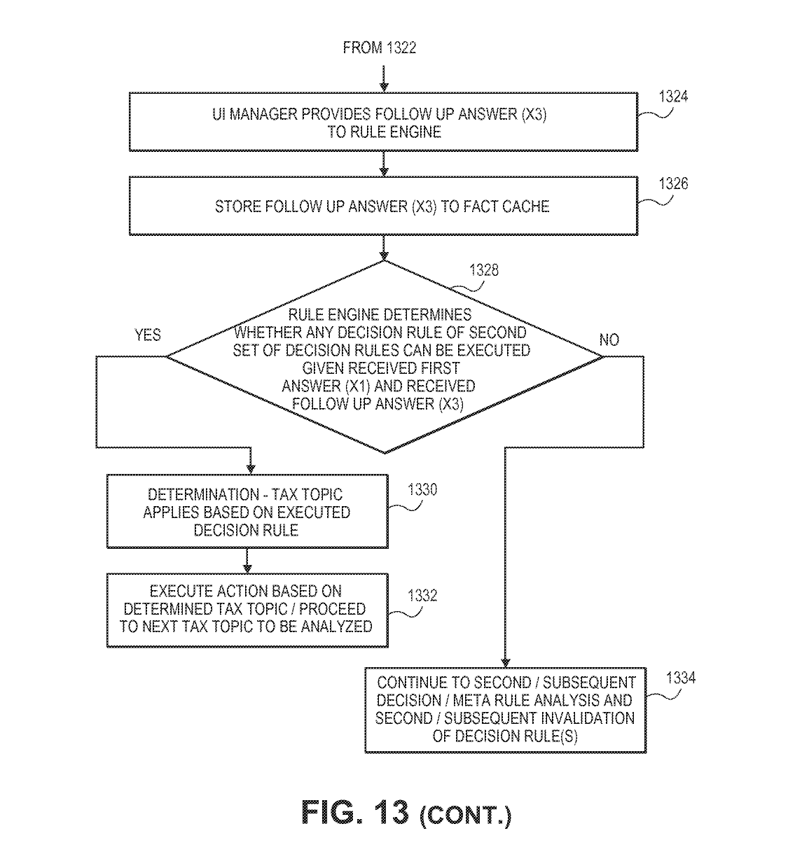

However, the result of 1210 is that, at 1216, only a portion of inputs needed for the decision rule's elements or conditions 1102 have been received such that no decision rule 462d can be executed and no determination 550 is made, then at 1218, the personalization module 640 proceeds to FIG. 13 for performing decision/meta rule analysis and potential decision rule invalidation.

Referring to FIG. 13, at 1302, the personalization module 640 analyzes the meta rules 462mi of a first meta rule set that specify when a decision rule 462d can be invalidated (e.g., given current and future answers 533 or inputs, the decision cannot be executed and is thus invalidated), and at 1304, determines which meta rule 462mi of the first meta rule set applies and which decision rule(s) 462d should be invalidated as a result of the applicable meta rule(s) 462mi. In the illustrated embodiment, at least one meta rule 462mi is applicable to invalidate at least one decision rule 462d given that the meta rules 462mi for invalidation were generated based on the inverses 1102i of each decision rule element or condition 1102. Thus, at 1306, the applicable invalidation meta rule 462mi is executed to invalidate decision rule 462d such that the invalidated decision rule 462 will no longer be available for selection.

For example, if user input 533 received in response to the first question 532 was “x1” then referring to FIG. 11B, this triggers invalidation meta rule 462mi “Additional_r1: if x1 then invalidate (R3)” which results in invalidation of decision rule “R3: ˜x1 and x4” since decision rule R3 requires an element “˜x1” whereas the input received is “x1” such that R3 can never be executed since input received is the opposite of what is required. As noted above, embodiments are described with reference to binary “Y/N” responses which provide for clearly defined inverses 1102i of elements 1102, but embodiments are not so limited since other system configurations may be utilized for response formats other than “Y/N” binary responses. Accordingly, by invalidating decision rule R3, what remains of the set of generated decision rules is a subset including decision rules R1 and R2.

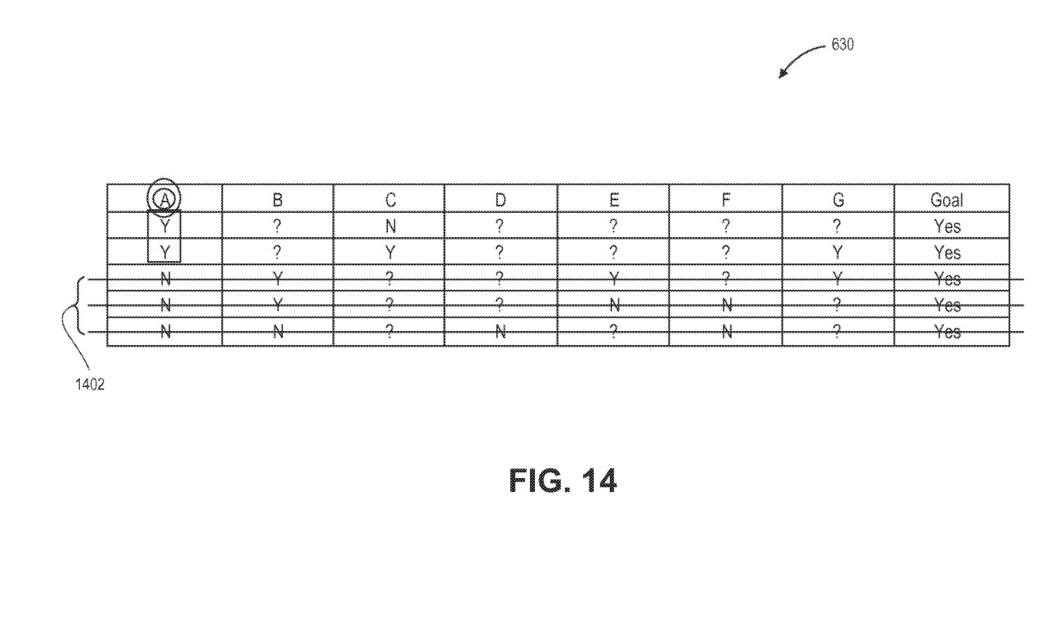

Explained in a different way, invalidation of a decision rule 462 by execution of a meta rule 462mi results in “crossing out” one or more rows of the decision table 630 from which decision rules 462d were directly derived. Thus, for example, referring again to FIG. 10, and with further reference to FIG. 14A, when question A is selected as the initial question 533 to be presented to the user 415 (FIG. 14A), the user 415 may respond with an answer “Y” 533 (FIG. 14B, circling “Y” response to question A in the first column), and applicable meta rules 462mi are executed to invalidate three decision rules 462d (bottom three rows in the decision table shown in FIG. 14C). This results in a subset of the generated decision rules 462d, i.e., only two of the five original rows of the decision table are not crossed out, or only two of the five generated decision rules 462 remain as decision rules 462 that have the potential to fire or be executed given the current status of answers or inputs 533 received from the user 415. Thus, the result of decision rule 462d invalidation is a reduced set of decision rules 462, or a subset of the first set of decision rules 462d.

Referring again to FIG. 13, at 1308, the personalization module 460 identifies one or more meta rules 462mr in the second set of meta rules that are applicable to the 462d that remain following invalidation in the reduced set or subset of decision rules 462d.

Referring to FIGS. 11A and 11C, and continuing with one example in which decision rule R3 was invalidated leaving decision rules R1 and R2 in the subset, meta rule 462mr “R3_: if valid(R3) then need (x1, x4)” no longer applies since R3 was already invalidated, such that meta rules 462mr “R1_: if valid(R1) then need(x1, x2)” and “R2_: if valid(R2) then need(x1, x3)” apply. In other words, at 1310, the personalization module 460 determines that inputs x1, x2 and x3 are needed to satisfy the conditions or elements of the remaining decision rules 462d (R1 and R2) and the inputs needed can be stored to fact cache 551 as necessary so that the needed inputs can be recalled at 1312 by, for example, “Insert_fact(valid(R1))” and “Insert_fact(valid(R2)).

Continuing with reference to FIG. 13, at 1314, the personalization module 460 determines which question 532 to select for follow up based on needed inputs determined at step 1312 and accesses the fact cache 551 to determine what is already known about x1, x2, x3, and determines, at 1314, that x1 is already known (answer 533 to first question 532) thus leaving unknown x2, x3. Fact cache 551 checks may be performed by, for example forming a command such as the following (pseudo code): Array return_varibles=[ ]; For each v in (x1, x2, x3) If find_in_fact_cache(r) or find_in_fact_cache(˜r) Continue; Else Insert into return_variables.

At 1318, one of the unknown x2, x3 is selected (e.g., x3 is selected), and a question 532 requesting an answer 533 concerning x3 is provided to the UI manager 530, which presents the follow up question 532 concerning x3 to the end user at 1320.

The “select” command can be configured to select from needed inputs and associated questions in various ways. For example, in one embodiment, the personalization module 460 can assort the importance or relevance of the inputs and/or remaining questions utilizing a global ranking of questions or inputs and applying the global ranking indiscriminately. Other embodiments may involve machine learning methods for creating conditional probability distributions for ranking remaining inputs and/or questions. For example, it the user 415 has already provided data or responses indicating that a child of the user is a US citizen, a certain question may be the most relevant for follow up, whereas not knowing this information, another question may be selected for follow up. Accordingly, it will be understood that various criteria and methods may be utilized to select the subject of one or more questions 532 following invalidation of one or more decision rules 462d, and a “select” command may involve multiple inputs that are identified by a meta rule 462mr, or a single input identified by a meta rule 462mr.

With continuing reference to FIG. 13, at 1322, the user 415 responds to the presented follow up question 532, which is received by the UI manager 530, and at 1324, the UI manager 530 the UI manager 530 provides the user's answer 533 to the personalization module 460 or rule engine 540, which stores the received follow up answer 533 to fact cache 551.

At 1328, the rule engine 540 determines whether any remaining decision rule 462d of can be executed given the previously received first answer x1 and the currently received follow up answer x3. In the illustrated example shown in FIG. 11A, the rule engine 540 determines whether any remaining decision rule 462d of second set of decision rules can be executed given the previously received first answer (x1) and the follow up answer (x3). If so, then that decision rule 462d is executed at 1330. Continuing with the example shown in FIG. 11A, decision rule R2 requires elements x1 and x3, such that, having receive inputs x1 and x3, the required elements for R2 have been received such that decision rule R2 can now be fired or executed and decision rule R2 indicates that the tax topic applies to the user 415. As explained above, at 1332, a subsequent action based on that tax topic may then be executed, and the personalization module 460 may proceed to process the next tax topic reflected in another decision graph 620 and decision table 630, and to generate the next set of decision rules 462d and meta rules 462m for the next topic such that method steps discussed above are repeated for each subsequent topic and sets of rules 462 generated from respective decision table 630, which are based on or derived from respective directed graphs 620, which are based on or derived from respective flow charts 610.

However, continuing with FIG. 13, at 1334 if no decision rule 462d can be executed given the user input or answers 533 received thus far, then the personalization module 640 continues to process decision rules 462d, meta rules for invalidation 462mi and meta rules 462mr for specifying required inputs to decision rules to invalidate one or more decision rules 462d, select further follow up questions 532, receive further answers or input 533 from the user 415, which is used to determine whether any remaining decision rule 462d that was not invalidated can be executed, and so on, until at least one decision rule 462d is executed to determine whether a tax topic applies to the user 415. Thus, the analysis and execution of decision rules 462d and meta rules 462m is repeated a decision rule 462 is executed or all decision rules are invalidated in the even that user inputs do not meet the requirements of the elements of any decision rule 462d.

Operation of embodiments is otherwise generally illustrated in FIG. 14, which shows how after an initial execution of meta rules 462mi to invalidate multiple decision rules 462d (represented as three crossed outs 1402 of rows), the personalization module 460 selected “G” from candidate questions “C” and “G” such that if a user then answered “N” (whereas question “G” requires a “Y” answer in view of the “don't care” alternative, then a further decision rule 462d would be invalidated, and so on.

In other words, the crossing operations shown in FIG. 14 can be summarized as, initially, any flow chart that describes the decision logic is crafted or received, and is transformed or converted into a directed graph in which each node represents a question the user needs to be asked. For example, in the dependents qualification topic, node A could mean “is the child older than 18?”, while node B could mean “did the child support him/herself more than 50% financially last year?” Considering that each path from the beginning node to the termination node or goal can independently form a checking rule, all such paths within the directed graph can be enumerated and converted into a decision table, which may then be used to ask any question in any order and gain insight about the user's situation because of the fact that the rows (rules) in the decision table are now independent from each other. This leads to a question being selected for presentation to the user based on a user's answer or input, and all rows that cannot be satisfied in the decision table are crossed out, questions in the remaining rows are collected, and a question is selected from the collection, and the process can repeat until a determination or goal is reached, or an empty collection results.

While embodiments are described above with reference to at least one of the decision rules 462d being invalidated each time meta rules 462m are invoked, this may not be the case since it may be that sometimes no decision rule 462d is invalidated and eliminated given the rules and inputs received. This does not affect the effectiveness or correctness of embodiments. Thus, it will be understood that embodiments described above are provided to illustrate one manner in which embodiments may be implemented in a non-limiting manner.

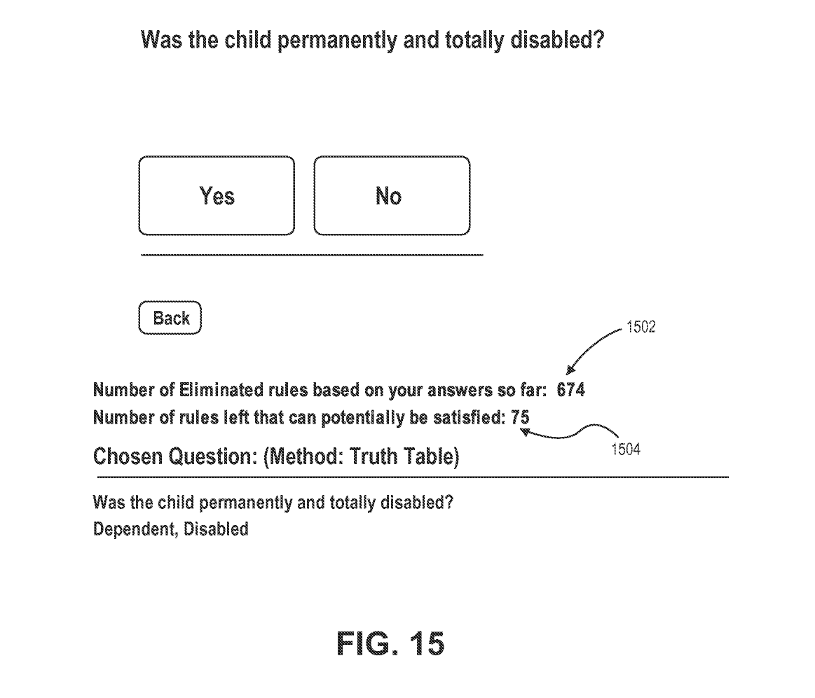

FIG. 15 illustrates an example of results achieved by embodiments on a larger scale and shows that after one or more iterations of decision rule 462d and meta rule 462m analysis, of all of the decision rules 462d applicable to a particular topic, a notification 1502 indicates that 674 decision rules 462d have been eliminated, and a further notification 1504 indicates that 75 decision rules 462d remain and may potentially be satisfied or executed given the inputs received thus far. Thus, when the user 415 answers the selected follow up question “Was the child permanently and totally disabled?” the resulting answer may, for example, result in elimination of 74 of the 75 remaining or potential decision rules 462d. Thus, the one remaining decision rule 462d may then be executed to make a determination whether a tax topic applies to the user 415. Or, the follow up answer may result in further decision rule 462d invalidation, e.g., such that of the 75 rules that could potentially be satisfied, the answer to the displayed question may invalidate 50 of those decision rules 462, thus resulting in a smaller subset of 25 decision rules remaining that potentially could execute or be satisfied depending on additional inputs or answers by the user to further follow up questions.

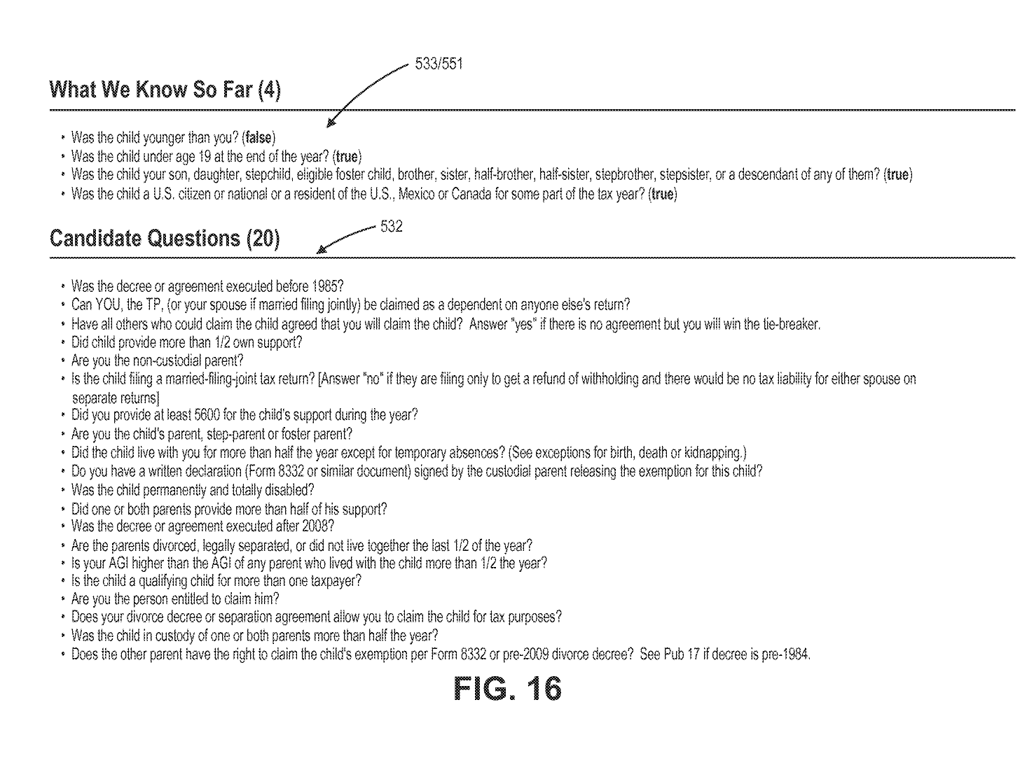

For example, FIG. 16 illustrates that what inputs or answers 533 have been received thus far and have been stored to fact cache 551, and 20 questions 532 that are associated with remaining decision rules 462d and that can be selected for presentation to the user 415.

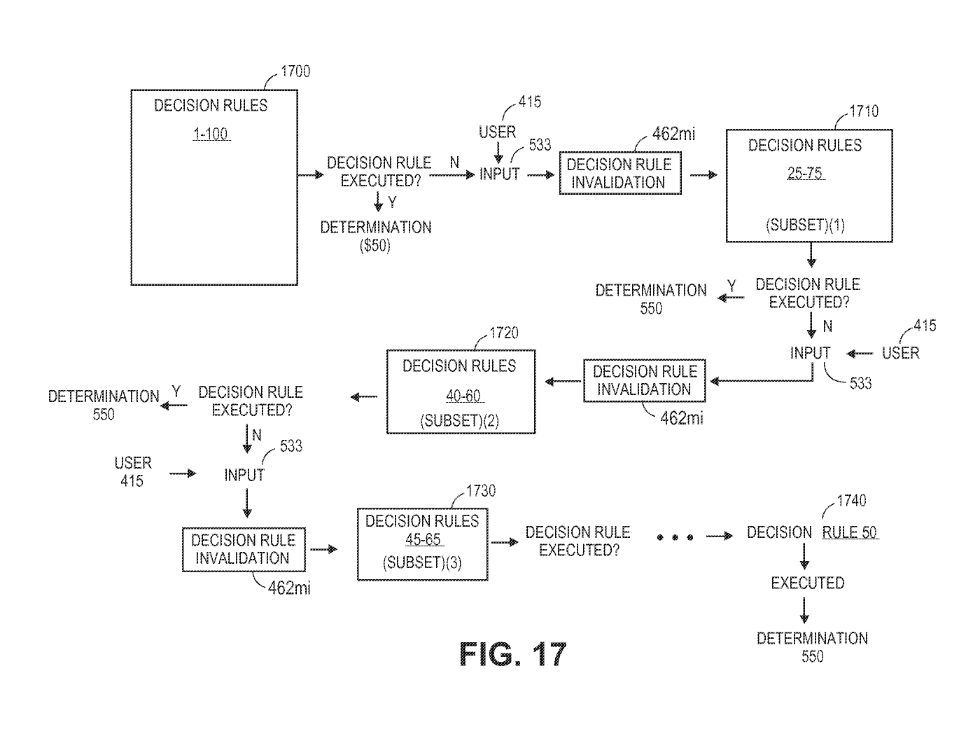

Having described how embodiments utilized generated rules of different types, FIG. 17 further generally illustrates how embodiments may be executed to perform multiple iterations of invalidating decision rules 462d to narrow the field of questions 432 for selection and presentation to the user 415, and eventually identifying a particular decision rule 462d to execute to determine whether a tax topic applies to the user 415.

In the example shown in FIG. 17, the personalization module 460 begins with a first set 1700 of decision rules (e.g., decision rules 1-100), and based on the user's first input or answer 533 to a first question 532, if a decision rule 426d can execute, it is executed and the determination 550 is made, otherwise one or more decision rules 426d are invalidated by one or more meta rules 462mi of a first meta rule set, thus resulting in, for example, a subset 1710 or decision rules 25-75 remaining as decision rules 462d that may potentially be executed. Meta rules 462mr of the second meta rule set are used to determine which inputs or elements are required for the remaining decision rules 25-75, and one input and associated question 532 are selected and presented to the user 415, and in response the user 415 provides a second answer 533. If a decision rule 426d (of decision rules 25-75) can execute with the second answer 533 or a combination of the first and second answers 533 stored in fact cache 551, that decision rule 426d is executed and the determination 550 is made. Otherwise one or more additional decision rules 426 are invalidated by one or more meta rules 462mi of the first meta rule set, thus resulting in, for example, a subset 1720 of decision rules 40-60 remaining Meta rules 462mr of the second meta rule set are used to determine which inputs are required for the remaining decision rules 40-60, and one input and associated question 532 is selected and presented to the user 415, and in response the user provides a third answer 533. If a decision rule 426d (of the subset 1720 of decision rules 40-60) can execute with the third answer, or a combination of two or more of the first, second and third answers stored in fact cache 551, that decision rule 426d is executed and the determination 550 is made. Otherwise one or more additional decision rules 426d are invalidated by one or more meta rules 462mi of the first meta rule set, thus resulting in, for example, a subset 1730 of decision rules 45-55 remaining Meta rules 462mr of the second meta rule set are used to determine which inputs are required for the remaining decision rules 45-55, and one input and associated question 532 are selected and presented to the user 415, and in response the user provides a fourth answer 533. These iterations can continue (“ . . . ”) until, for example, it is determined that a subset 1740 including decision rule 426d can be executed based on the received first, second, third and fourth answers stored in fact cache 551, and that decision rule 426d is executed to determine 550 whether the tax topic applies to the user 415 is made.

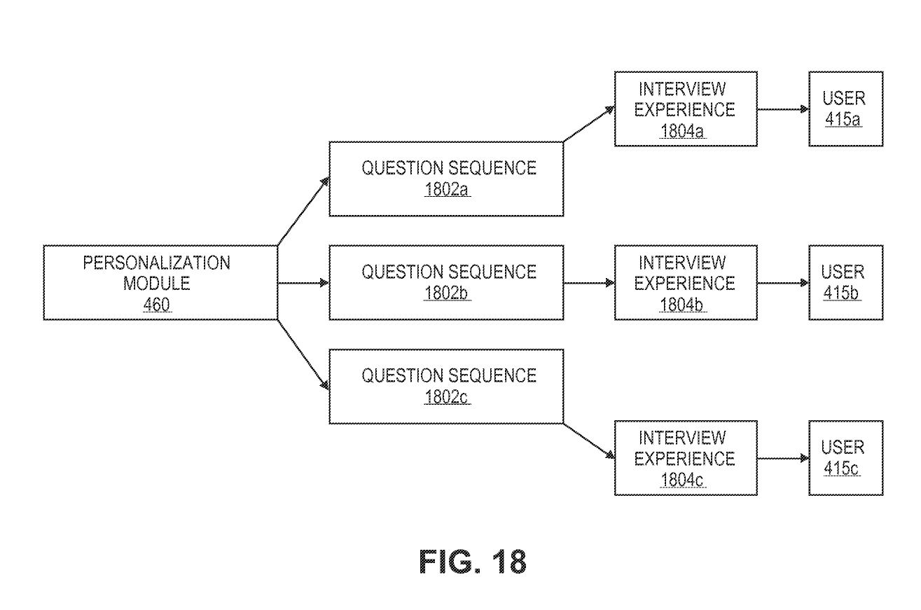

Thus, as shown in FIG. 17 and as further generally illustrated in FIG. 18, as a result of embodiments selecting questions and invaliding rules and eliminating questions associated therewith utilizing generated meta rules 462m, the personalization module 460 may generate question sequences 1802a-c that are adapted to provide different interaction or interview experiences 1804a-c for different users 415a-c as respective users 415a-c provide their respective answers 533 to questions 532 selected based at least in part upon generated decision and meta rules 462d, 462m.

Further, since embodiments are able to disassociate questions from pre-determined sequences of source flow charts 610 and paths through directed graphs 620 by use of generated decision rules 426d and meta rules 426m, embodiments may ask various questions in various sequences, even if that sequence is different compared to the sequence specified by a source flow chart 610 or by a path through a directed graph 620.

Thus, for example, relative to a pre-determined sequence of questions 1-15, embodiments may involve receiving inputs and invalidating certain decision rules 426d such that question 3 was initially selected and the user's answer to that question is Input I1, decision rules 7, 10, 12 and 13 are invalidated, leaving a first subset of decision rules including decision rules 1-6, 8-9, 11 and 14-15. Question 5 may then be selected, and the user's answer to Question 5 is Input I2. Execution of generated decision and meta rules based on I2, or the combination of I1 and I2, may result in invalidation of one or more additional decision rules 426d such as decision rules 9, 11 and 15, which results in elimination of associated questions and leaves a second subset of decision rules including rules 1-6, 8 and 14. Question 8 may then be selected, and the user's answer to Question 8 is I3. Execution of generated decision and meta rules based on I3, or the combination of two or more of I1, I2 and I3, may result in invalidation of additional decision rules 1, 2, 4 and 14, and elimination of associated questions (identified by “square” around the question number), thus leaving a third subset of decision rules including decision rule 6 (the sole remaining decision rule in this example). Decision rule 6 is executed to determine whether the tax situation or topic applies to the user.

Further, given how embodiments function, certain questions that are eliminated as a result of invalidated decision rules 426d would have otherwise been asked of the user 415 if the source flow chart 610 with the fixed pre-determined sequence 612 were utilized. Embodiments are not only able to ask various questions 532 in various sequences, but may also eliminate questions that from a pre-determined sequence 612 of a flow chart 610 or eliminate a question corresponding an intermediate node in the directed graph 620. Thus, embodiments not only provide a more meaningful personalized interaction experience, but also focus on questions that are deemed to be more relevant or the most relevant while eliminating those that do not need to be asked (as a result of decision rules not being able to execute given answers received) in order to reach the same determination or conclusion.

Additionally, while certain embodiments are described with reference to selecting a question, proceeding with presenting the question, and receiving a response or answer, then proceeding with a follow up question, and so on, other embodiments may involve execution of rule invalidation followed by selection and presentation of multiple or all remaining questions resulting from remaining decision rules that were not invalidated. For example, in certain embodiments, presentation of multiple questions can be conditioned upon the number of questions being less than a pre-determined number so that the user is not overloaded with answering too many questions at one time. Thus, one or multiple answers or inputs may be received and processed, and a single decision rule may be executed after a single round of invalidation or multiple rounds of invalidation, or when multiple answers are received in response to multiple selected and presented questions, at least one decision rule, possibly multiple decision rules, may execute following receipt of multiple answers.

Accordingly, it will be understood that embodiments are not limited to executing generated rules to select a single question and receiving a single answer in response thereto. Further, embodiments may involve performing rule invalidation, selecting and presenting a question to the user following application of generated rules, an answer is received, and so on, until a number of remaining decision rules or the number of associated remaining questions, does not exceed a pre-determined number. In response to this result, all of the remaining questions for all of the remaining inputs or all of the remaining questions associated with remaining decision rules can then be presented to the user, and multiple answers or responses can processed.

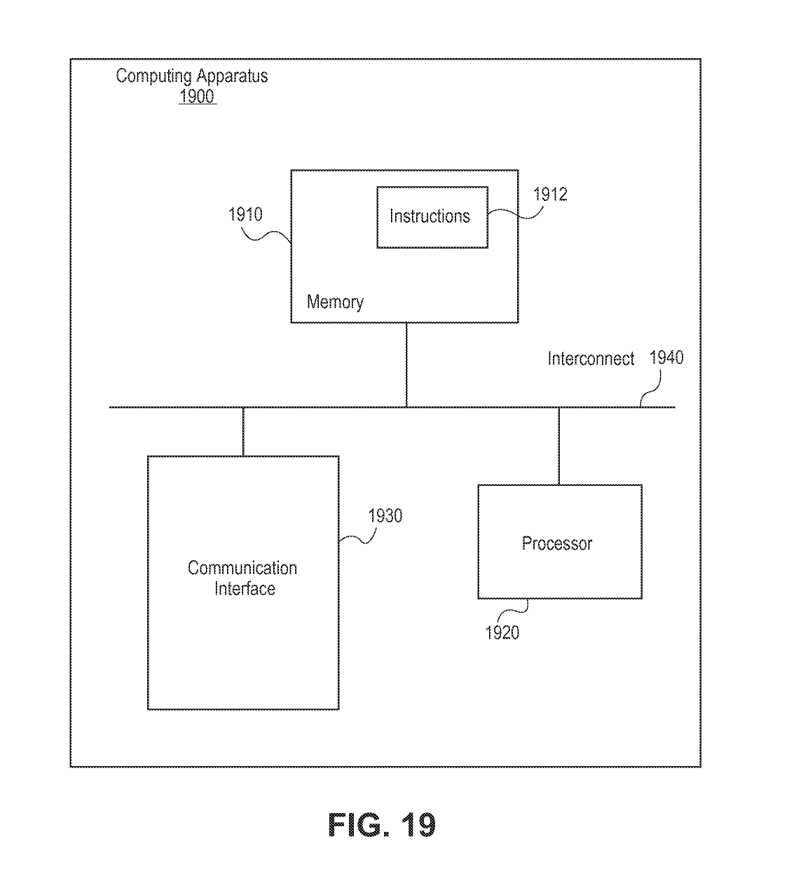

FIG. 19 generally illustrates certain components of a computing device 1900 that may be utilized to execute embodiments and that includes a memory 1910, program instructions 1912, a processor or controller 1920 to execute instructions 1912, a network or communications interface 1930, e.g., for communications with a network or interconnect 1940 between such components. The memory 1910 may be or include one or more of cache, RAM, ROM, SRAM, DRAM, RDRAM, EEPROM and other types of volatile or non-volatile memory capable of storing data. The processor unit 1920 may be or include multiple processors, a single threaded processor, a multi-threaded processor, a multi-core processor, or other type of processor capable of processing data. Depending on the particular system component (e.g., whether the component is a computer or a hand held mobile communications device), the interconnect 1940 may include a system bus, LDT, PCI, ISA, or other types of buses, and the communications or network interface may, for example, be an Ethernet interface, a Frame Relay interface, or other interface. The network interface 1930 may be configured to enable a system component to communicate with other system components across a network which may be a wireless or various other networks. It should be noted that one or more components of computing device 1900 may be located remotely and accessed via a network. Accordingly, the system configuration provided in FIG. 19 is provided to generally illustrate how embodiments may be configured and implemented.

Method embodiments or certain steps thereof, some of which may be loaded on certain system components, computers or servers, and others of which may be loaded and executed on other system components, computers or servers, may also be embodied in, or readable from, a tangible medium or computer-readable medium or carrier, e.g., one or more of the fixed and/or removable data storage data devices and/or data communications devices connected to a computer. Carriers may be, for example, magnetic storage medium, optical storage medium and magneto-optical storage medium. Examples of carriers include, but are not limited to, a floppy diskette, a memory stick or a flash drive, CD-R, CD-RW, CD-ROM, DVD-R, DVD-RW, or other carrier now known or later developed capable of storing data. The processor 1920 performs steps or executes program instructions 1912 within memory 1910 and/or embodied on the carrier to implement method embodiments.

Although particular embodiments have been shown and described, it should be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

For example, while certain aspects of embodiments are described as being performed by particular components (e.g., by a personalization module or rule engine), it will be understood that embodiments are not so limited, and that embodiments can be executed by or integrated within a tax preparation application in different ways.

As a further example, it will be understood that embodiments may involve determining and/or generating data structures or representations including a flow chart, directed graph and decision table, or receiving a data structure or representation that has already been generated, or receiving one data structure or representation and generating or deriving others based thereon.

Moreover, while embodiments are described with reference to a user answering questions, embodiments are able to roll back application of generated rules and associated determinations in the event that a user changes or retracts an answer.

Further, while certain embodiments are described with reference to processing of a decision table having Boolean variables, other embodiments may involve other comparison or conditional statements.

Additionally, while certain embodiments are described with reference to selecting particular questions, embodiments are not so limited to asking one question and answering a question one by one. Rather, embodiments can account for question redundancy, and the more questions asked, the more decision rules can be invalidated, or the more row cross outs that can be executed within the decision table.

While multiple embodiments and variations of aspects of the invention have been disclosed herein, such disclosure is provided for purposes of illustration only. Where methods and steps described above indicate certain events occurring in certain order, those of ordinary skill in the art having the benefit of this disclosure would recognize that the ordering of certain steps may be modified and that such modifications are in accordance with the variations of the invention. Additionally, certain of the steps may be performed concurrently in a parallel process as well as performed sequentially. Thus, the methods shown in various flow diagrams are not intended to be limited to a particular sequential order, particularly in instances in which certain steps may or may not be performed. Accordingly, embodiments are intended to exemplify alternatives, modifications, and equivalents that may fall within the scope of the claims.

1. A computer-implemented method, comprising:
a computer, programmed according to instructions of a tax return preparation application operable to prepare an electronic tax return, transforming at least one representation of questions pertaining to a tax topic into a first transformed representation of questions;
the computer, programmed according to instructions of the tax return preparation application, generating a first rule set based at least in part upon the first transformed representation of questions pertaining to the tax topic, and generating a second rule set and a third rule set based at least in part upon the first rule set;
the computer, programmed according to instructions of the tax return preparation application, receiving a first input in response to a first question presented to the user and determining whether any rule of the first rule set can be executed based on the first input; and
when no rule of the first rule set can be executed,
the computer, programmed according to instructions of the tax return preparation application, executing at least one rule of the second rule set to invalidate at least one rule of the first rule set resulting in a first subset of the first rule set, and the computer, programmed according to instructions of the tax return preparation application, determining a second question to present to the user based at least in part upon at least one rule of the third rule set involving at least one rule of the first subset,
else executing a rule of the first rule set to determine whether the tax topic applies to the user.

2. The method of claim 1, the first transformed representation comprising a decision table, respective rules of the first rule set being based on respective rows of the decision table.

3. The method of claim 2, a number of rows in the decision table being the same as a number of rules in the first rule set.

4. (canceled)

5. The method of claim 1, wherein the first transformed representation is a decision table that is based at least in part upon a second transformed representation of questions pertaining to the tax return topic, wherein the second transformed representation of questions is transformed into the first representation of questions

6. The method of claim 5, the second transformed representation comprising a directed graph, wherein
a beginning node and intermediate nodes of the directed graph correspond to respective questions,
inter-node connections of the directed graph correspond to respective answers to respective questions, and
a terminal node of the directed graph indicates whether the tax return topic applies to the user.

7. The method of claim 6, further comprising the computer, programmed according to the tax preparation application, generating the directed graph.

8. The method of claim 7, the directed graph being generated based at least in part upon a third representation of questions pertaining to the tax return topic, wherein the third representation of questions is transformed into the second representation of questions, and wherein the second transformed representation of questions is transformed into the first representation of questions.

9. The method of claim 8, the third representation comprising a flow chart.

10. The method of claim 9, the flow chart comprising a static sequence of questions, wherein the beginning and intermediate nodes of the directed graph are based on respective questions or decisions blocks of the flow chart, and respective connections of the directed graph are based on respective answers to respective questions or decision blocks of the flow chart.

11-12. (canceled)

13. The method of claim 8, the first transformed representation comprising a table, the second transformed representation comprising a directed graph, and the third representation comprising a flow chart.

14. The method of claim 13, wherein a beginning node and intermediate nodes of the directed graph are based on respective questions of the flow chart, inter-node connections of the directed graph are based on respective answers to respective questions of the flow chart, and a terminal node of the directed graph indicates whether the tax return topic applies to the user, respective rows of the table are based on respective paths from the beginning node to the terminal node, and each rule in the first rule set is based on a row in the table.

15. The method of claim 1, wherein each rule of the first rule set is executable to generate a result indicating whether the tax return topic applies to the user.

16. The method of claim 1, each rule of the selected first subset being a rule that is not executed based only upon the first input but that may potentially be executed based at least in part upon the received first input and at least one other input.

17. The method of claim 1, wherein the second rule set and the third rule set do not include any rule that is executable to generate a result indicating whether the tax return topic applies to the user.

18. The method of claim 1, the second rule set comprising a first meta data rule set based at least in part upon the first rule set, and the third rule set comprising a second meta data rule set based at least in part upon the first rule set.

19. The method of claim 18, rules of the first meta rule set being based at least in part upon inverses of respective operands of respective rules of the first rule set.

20. The method of claim 19, further comprising the computer, programmed according to the tax preparation application:
parsing rules of the first rule set to determine respective operands of respective rules of the first rule set;
for each operand of each rule of the first rule set, determining an inverse of the operand, wherein each rule of the first meta rule set specifies how at least one rule of the first rule set is invalid based at least in part upon at least one determined inverse.

21. The method of claim 20, each rule of the first meta rule set involving at least one inverse of an operand of at least one rule of the first rule set.

22. The method of claim 18, rules of the second meta rule set indicating which inputs are needed in order for respective rules of the first rule set to be valid and executable.

23. The method of claim 18, rules of the first meta rule set being based at least in part upon inverses of respective operands of respective rules of the first rule set, each rule of the first meta rule set involving at least one inverse of an operand of at least one rule of the first rule set, and rules of the second meta rule set indicating which inputs are needed in order for respective rules of the first rule set to be valid and executable.

24. The method of claim 1, the tax return topic comprising whether the user qualifies for a tax deduction or a tax credit.

25. The method of claim 1, wherein when at least one rule of the first rule set can be executed, further comprising the computer, programmed according to the tax preparation application, executing the at least one rule to determine whether the tax return topic applies to the user.

26. The method of claim 25, further comprising the computer, programmed according to the tax preparation application, executing an action following determination of the result.

27. The method of claim 26, the action comprising
identifying at least one tax form of the electronic tax return pertaining to the tax return topic, and
populating the at least one tax form with data of answers based on inputs previously received by the computer.

28. The method of claim 26, the action comprising:
determining a pre-determined sequence of interview screens or questions pertaining to the tax situation to the user; and
presenting the pre-determined sequence of interview screens or questions to the user.

29. The method of claim 26, the action comprising notifying the user that a different version of the tax preparation application should be utilized.

30. The method of claim 1, wherein no rule of the first rule set was executed based on the first input resulting in selection of the first subset, the method further comprising the computer, programmed according to the tax preparation application:
receiving a second input in response to the second question and determining whether any rule of the first subset can be executed based on the first input and the second input; and
when no rule of the first subset can be executed, the computer executing at least one rule of the second rule set to invalidate at least one rule of the first subset resulting in a second subset of the first rule set, and determining a third question to present to the user based at least in part upon at least one rule of the third rule set involving at least one rule of the second subset, else executing a rule of the first subset to determine whether the tax return topic applies to the user.

31. The method of claim 30, wherein no rule of the first subset was executed based on the first input and the second input resulting in selection of the second subset, the method further comprising the computer, programmed according to the tax preparation application:
receiving a third input in response to the third question and determining whether any rule of the second subset can be executed based on the first input, the second input and the third input; and
when no rule of the second subset can be executed, the computer executing at least one rule of the second rule set to invalidate at least one rule of the second subset resulting in a third subset of the first rule set, and determining a fourth question to present to the user based at least in part upon at least one rule of the third rule set involving at least one rule of the third subset, else executing a rule of the second subset to determine whether the tax return topic applies to the user.

32. The method of claim 1, wherein a rule of the first rule set was executed based on the first input resulting in determining whether the tax return topic applies to the user, the method further comprising the computer, programmed according to the tax preparation application:
determining another tax return topic;
generating a fourth rule set based at least in part upon a fourth representation of questions pertaining to the other tax return topic;
generating a fifth rule set and a sixth rule set based at least in part upon the fourth rule set;
receiving a second input in response to a second question presented to the user and determining whether any rule of the fourth rule set can be executed based on the second input; and
when no rule of the fourth rule set can be executed, the computer executing at least one rule of the fifth rule set to invalidate at least one rule of the fourth rule set resulting in a subset of the fourth rule set, and determining a third question to present to the user based at least in part upon at least one rule of the third rule set involving at least one rule of the subset of the fourth rule set, else executing a rule of the fourth rule set to determine whether the other tax return topic applies to the user.

33. The method of claim 1, wherein a sequence of questions beginning with the first question followed by the second question is different compared to a pre-determined sequence of questions programmed within the tax preparation application for that tax return topic.

34. The method of claim 1, the first representation comprising a table, respective rules of the first rule set being based on respective rows of the table, and the second representation comprising a directed graph, wherein a beginning node and intermediate nodes of the directed graph correspond to respective questions, inter-node connections correspond to respective answers to respective questions, and a terminal node of the directed graph indicates whether the tax return topic applies to the user, wherein a sequence of questions beginning with the first question followed by the second question is different compared to a pre-determined sequence of questions of a path through the directed graph.

35. The method of claim 34, wherein the sequence beginning with the first question followed by the second question skips or does not include at least one question within the path through the directed graph that includes the first question and the second question.

36. The method of claim 34, the directed graph being generated based at least in part upon a third representation of questions pertaining to the tax return topic comprising a flow chart including a pre-determined sequence of questions, wherein the beginning and intermediate nodes of the directed graph are based on respective questions or decisions blocks of the flow chart, and respective connections of the directed graph are based on respective answers to respective questions or decision blocks of the flow chart, and wherein the sequence beginning with the first question followed by the second question skips or does not include at least question within the path through the directed graph and within the flow chart including the first question and the second question.

37. The method of claim 1, wherein a sequence of questions including the first question and the second question is not a pre-determined sequence.

38-39. (canceled)
